(19) United States
(12) Patent Application Publication
(10) Pub. No.: US 2015/0037768 A1
(43) Pub. Date: Feb. 5, 2015

(54) METHODS FOR REDUCING CHILDHOOD OBESITY AND FOR CALCULATING CHILDHOOD OBESITY RISK

(71) Applicants: Jose Maria Saavedra, Morristown, NJ (US); Heidi Marie Storm, Folsom, CA (US); Anne McLaughin Dattilo, State College, PA (US); Nancy Anne Moore, Ellicott City, MD (US); Keriann Hunter Uesugi, Evanston, IL (US)

(72) Inventors: Jose Maria Saavedra, Morristown, NJ (US); Heidi Marie Storm, Folsom, CA (US); Anne McLaughin Dattilo, State College, PA (US); Nancy Anne Moore, Ellicott City, MD (US); Keriann Hunter Uesugi, Evanston, IL (US)

(73) Assignee: NESTEC S.A., Vevey (CH)

(21) Appl. No.: 14/233,122

(22) PCT Filed: Jul. 20, 2012
(86) PCT No.: PCT/US2012/047554

§ 371 Date: Apr. 9, 2014

Related U.S. Application Data
(60) Provisional application No. 61/510,612, filed on Jul. 22, 2011.
(60) Provisional application No. 61/560,329, filed on Nov. 16, 2011.
(60) Provisional application No. 61/672,945, filed on Jul. 18, 2012.

(51) Int. Cl. G09B 5/00

(52) U.S. Cl. CPC G09B 5/00
USPC 434/236

(57) ABSTRACT

The present disclosure provides personalized methods for preventing and/or reducing early childhood obesity that are based upon identifying a child's individual risk of obesity and tailoring methods to prevent or reduce obesity. The methods are based on early inception, anticipatory guidance, sequential guidance, and nutritionally and developmentally appropriate dietary and parental feeding behaviors guidance, all specifically targeting factors that have been associated with childhood obesity. The methods use an obesity risk calculator to tailor the methods to address an individual child's risk with regard to specific modifiable factors associated with obesity. The present methods may help instill early healthy eating habits and nutritious food preferences for infants and young children, promote an appropriate early growth trajectory, and a long term weight status that is consistent with public policy recommendations and associated with long term health.

### BACKGROUND

The present disclosure relates generally to health and nutrition. More specifically, the present disclosure relates to methods for calculating childhood obesity risk and using the information as part of a method of reducing childhood obesity.

Body weight status of children less than two years of age has been demonstrated to track through the toddler years, and subsequently into adulthood. At present, approximately 10-20% of infants and toddlers in the United States (“US”) are overweight, setting the stage for an increased risk of lifelong obesity and its associated chronic diseases and health care costs. Interventions to successfully reduce rates of overweight in this young population have not been given adequate attention. Moreover, quantitative feeding recommendations or national food and nutrition guidelines are unavailable for US children, cared for at home, that are less than two years of age.

Critical periods for establishing dietary intake patterns, eating habits, and food preferences begin in infancy, and although plastic, are likely set by age two when children generally adopt the eating practices of the family. Parental feeding behaviors, if not causative for weight status in young children, are strongly associated with body weight and healthy food choices throughout childhood. Current research suggests that interventions to adjust food composition or caloric intake and increase physical activity, especially after infancy, have relatively little impact, and have been insufficient to curtail the increased prevalence of overweight affecting young children. Efforts to prevent excess weight gain during the school age years offers an approach that is simply too late. Twenty percent of preschool age children are already overweight.

Interventions that begin at birth, target multifaceted aspects of the diet, such as promotion of breastfeeding, and provide education to parents directly targeting factors related to healthy growth and obesity prevention are emerging as recommended research areas. Current evidence on obesity prevention points to specific dietary and physical activity/inactivity behaviors, but also calls for attention to parental feeding behaviors and awareness of appropriate responses to infant hunger and satiety cues that parents can adopt for their children to encourage a healthy growth and weight status. While helpful in the fight against childhood obesity, these tactics do not fully address many of the components that contribute to childhood obesity.

A crucial part of maintaining a healthy weight is understanding how various factors affect an individual's risk of overweight or obesity. This is particularly true for a child. Improved understanding by the parent of a child's obesity risk and the way that various factors affect that risk is essential to helping the parent raise a child with a healthy body weight during the first two years of life.

As such, there exists a need to provide a comprehensive nutritionally and developmentally appropriate personalized intervention based on calculated obesity risk, starting prior to birth, and designed to promote healthy dietary intake, feeding habits, and growth, in infancy and beyond.

### SUMMARY

The present disclosure provides methods for calculating childhood obesity risk and using that information to provide methods of reducing early childhood obesity. These methods are based upon early inception (e.g., third trimester of pregnancy), anticipatory guidance (e.g., prior to an infant reaching a specific developmental stage) tailored to each individual child based on the child's obesity risk level, and nutritionally and developmentally appropriate dietary and parental feeding behavior guidance, all specifically targeting factors that have been associated with childhood obesity. The methods provide a system to facilitate appropriate behavioral adoption by a caregiver and child under two years of age based on the identified, modifiable risk factors and accumulation of individual risk as identified by an obesity risk calculator. The presently disclosed methods may help instill individualized early healthy eating habits and nutritious food preferences for infants and young children, promote an appropriate early growth trajectory, and a long term weight status that is consistent with public policy recommendations and associated with long term health.

In a general embodiment, a method for reducing childhood obesity is provided. The method includes delivering to a caregiver a plurality of messages in an anticipatory and a sequential manner with respect to a child's developmental stage. The messages are related to factors associated with childhood obesity. The delivery is performed using a non face-to-face method of communication; and, the messages being personalized for the child based on the child's risk of becoming obese by age two as calculated using an obesity risk calculator.

In another embodiment, a method for reducing a body mass index of a child is provided. The method includes delivering to a caregiver a plurality of messages in an anticipatory and a sequential manner with respect to a child's developmental stage. The messages are related to factors associated with childhood obesity. The delivery is performed using a non face-to-face method of communication; and, the messages being personalized for the child based on the child's risk of becoming obese by age two as calculated using an obesity risk calculator.

In yet another embodiment, a method for reducing the risk of developing type 2 diabetes, hypertension, heart disease, chronic diseases or Syndrome X is provided. The method includes delivering to a caregiver a plurality of messages in an anticipatory and a sequential manner with respect to a child's developmental stage. The messages are related to factors associated with childhood obesity. The delivery is performed using a non face-to-face method of communication; and, the messages being personalized for the child based on the child's risk of becoming obese by age two as calculated using an obesity risk calculator.

In an embodiment, the caregiver is the biological mother of the child and a first-time mother. In an embodiment, the caregiver is not the biological mother of the child. In an embodiment wherein the caregiver is not the biological mother, every message disclosed herein may not be applicable to the caregiver (e.g., “provide breastmilk”).

In an embodiment, the delivery may begin in the mother's third trimester and last at least two years. Alternatively, delivery may begin after the child is born.

In an embodiment, the non face-to-face method of communication is a media source selected from the group consisting of selected from the group consisting of mailers, email, video, telephone, printed sources, web-related applications, mobile phone applications, computer implemented programs, or combinations thereof. In an embodiment, the media source is a website.

In an embodiment, the plurality of messages includes at least 3, 4, 5, 6, 7, 8, or more messages. The messages may relate to the factors selected from the group consisting of feeding and nutrition, feeding related behavior, or combinations thereof. At least one of the plurality of messages may be related to the feeding and nutrition factors and may be selected from the group consisting of “provide breast milk,” “provide nutritious complementary foods and beverages at the appropriate developmental stage,” “exclude sugar sweetened beverages for infants and limit them for toddlers,” or combinations thereof.

In an embodiment, the message is “provide breast milk,” and the message is first delivered to the caregiver in a third trimester of a mother of the child.

In an embodiment, the message is “provide nutritious complementary foods and beverages at the appropriate developmental stage,” and the message is first delivered to the caregiver when the child is about two months of age.

In an embodiment, the message is “exclude sugar sweetened beverages for infants and limit them for toddlers,” and the message is first delivered to the caregiver when the child is about two months of age.

In an embodiment, at least one of the plurality of messages is related to the feeding related behavior factors and is selected from the group consisting of “utilize responsive feeding practices,” “ensure that the child has adequate sleep,” “foster healthy eating behaviors through shared family meals and mealtime routines,” “limit TV and screen viewing time,” “provide opportunities for physical activity,” or combinations thereof.

In an embodiment, the message is “utilize responsive feeding practices,” and the message is first delivered to the caregiver at birth of the child.

In an embodiment, the message is “foster healthy eating behaviors through shared family meals and mealtime routines,” and the message is first delivered to the caregiver when the child is about six months of age.

In an embodiment, the message is “limit television and screen viewing time,” and the message is first delivered to the caregiver when the child is about four months of age.

In an embodiment, the message is “ensure that the child has adequate sleep,” and the message is first delivered to the caregiver when the child is about two months of age.

In an embodiment, the message is “provide opportunities for physical activity,” and the message is first delivered to the caregiver when the child is about four months of age.

In an embodiment, the developmental stage is selected from the group consisting of birth+, supported sitter, sitter, crawler, toddler, preschooler, or combinations thereof. The birth+developmental stage typically occurs between zero and four months. The supported sitter developmental stage typically occurs between four and six months. The sitter developmental stage typically occurs after about six months. The crawler developmental stage typically occurs after about eight months. The toddler developmental stage typically occurs after about twelve months. The preschooler developmental stage typically occurs after about 24 months. Developmental milestones associated with each developmental stage are provided below at Table 3.

In an embodiment, the method further includes providing the caregiver with at least one education tool selected from the group consisting of a menu planner, visuals of serving sizes, breastfeeding tracker, growth tracking tools, or combinations thereof. The at least one education tool may be provided to the caregiver by a media source selected from the group consisting of mailers, email, video, telephone, printed sources, web-related applications, mobile phone applications, computer implemented programs, or combinations thereof.

In an embodiment, the method further includes providing the caregiver with at least one support source selected from the group consisting of a registered dietitian, a certified lactation specialist, or combinations thereof. The caregiver may access the at least one support source using a media source selected from the group consisting of mailers, email, video, telephone, printed sources, web-related applications, mobile phone applications, computer implemented programs, or combinations thereof. In an embodiment, the caregiver may access the support source using a telephone.

In an embodiment, the method further includes calculating the child's risk of becoming obese by age two using an obesity risk calculator using an obesity risk calculator based on information collected regarding the modifiable factors associated with childhood obesity. The calculator may comprise at least two sub-components: a questionnaire and a science based algorithm for calculating risk.

In an embodiment, the questionnaire includes questions about the caregiver's current level of performing the modifiable risk factors along with basic biological or demographic information of the mother of the child.

In an embodiment, one to all of the modifiable risk factors are assessed in the obesity risk calculator depending on the child's age.

In an embodiment, at least one of the modifiable risk factors assessed in the obesity risk calculator is whether the caregiver chooses to feed the child breast milk and the risk factor is assessed in a third trimester of a mother of the child.

In an embodiment, at least one of the modifiable risk factors assessed in the obesity risk calculator is to what degree sugar sweetened beverages are excluded from the diet for infants and limited for toddlers, and the risk factor is assessed when the child is about two months of age.

In an embodiment, at least one of the modifiable risk factors assessed in the obesity risk calculator is whether the caregiver utilizes responsive feeding practices when caring for the child, and the risk factor is assessed after the birth of the child.

In an embodiment, at least one of the modifiable risk factors assessed in the obesity risk calculator is whether the caregiver fosters healthy eating behaviors through shared family meals and mealtime routines, and the risk factor is assessed when the child is about six months of age.

In an embodiment, at least one of the modifiable risk factors assessed in the obesity risk calculator is to what degree the caregiver limits television and screen viewing time, and the risk factor is assessed when the child is about four months of age.

In an embodiment, at least one of the modifiable risk factors assessed is assessed in the obesity risk calculator is whether the caregiver ensures that the child has adequate sleep, and the risk factor is assessed when the child is about two months of age.

In an embodiment, at least one of the modifiable risk factors assessed is assessed in the obesity risk calculator is to what degree the caregiver provides opportunities for physical activity for the child and the risk factor is assessed when the child is about four months of age.

In an embodiment, the risk of becoming obese by age two is calculated using an obesity risk calculator that assesses a plurality of the following modifiable risk factors: 1) whether the caregiver feeds the child breast milk, 2) whether the caregiver feeds the child using responsive feeding practices, 3) whether the caregiver provides nutritious complementary foods and beverages at the appropriate developmental stage, 4) whether the caregiver ensures that the child has adequate sleep, 5) to what degree the caregiver excludes sugar sweetened beverages for infants and limits them for toddlers, 6) whether the caregiver fosters healthy eating behaviors through shared family meals and mealtime routines, 7) how much time the caregiver allows the child to spend watching TV or having other screen viewing time, 8) and to what degree the caregiver provides opportunities for physical activity for the child.

In an embodiment, the calculator can generate the child's percent chance of becoming obese, as well as specific risk levels for each factor associated with childhood obesity.

In an embodiment, the caregiver is pushed into the obesity risk calculator at regular intervals. The results are then used to tailor the method to the individual child based on the level of obesity risk.

In still yet another embodiment, a method for reducing childhood obesity is provided. The method includes calculating the obesity risk of a child during the first two years of age based on personal history and modifiable risk factors leading to obesity, developing educational content including messages, tools and services tailored to mitigating the child's calculated obesity risk, and instructing, during a third trimester of a mother, the mother to perform, at a first future time, a first action related to feeding a child, the instructing occurring before the child is developmentally ready for the first action. The method further includes instructing a caregiver to perform, at a second future time, a second action related to feeding the child, the instructing occurring before the child is developmentally ready for the second action, the second future time being after the first future time. The instructing is performed with a non face-to-face method of communication. The method still further includes recalculating the child's obesity risk at regular intervals after birth and modifying the method based on the results of the obesity risk calculator.

In an embodiment, the caregiver is a first-time mother. The instructing may occur in an interrupted manner through at least the first two years of the child's life. In an embodiment, the non face-to-face method of communication is a media source selected from the group consisting of mailers, email, video, telephone, printed sources, web-related applications, mobile phone applications, computer implemented programs, or combinations thereof.

In an embodiment, the instructing occurs in an anticipatory and sequential manner with respect to the child's developmental stage. The developmental stage is selected from the group consisting of birth+, supported sitter, sitter, crawler, toddler, preschooler, or combinations thereof. The birth+ developmental stage typically occurs between zero and four months. The supported sitter developmental stage typically occurs between four and six months. The sitter developmental stage typically occurs after about six months. The crawler developmental stage typically occurs after about eight months. The toddler developmental stage typically occurs after about twelve months. The preschooler developmental stage typically occurs after about 24 months.

In an embodiment, the method further includes instructing a caregiver to perform, at a third future time, a third action related to feeding the child. The instructing may begin before the child is developmentally ready for the third action, and the third future time may be after at least one of the first and second future times.

In an embodiment, the actions are related to factors selected from the group consisting of feeding and nutrition, feeding related behavior, or combinations thereof.

In an embodiment, at least one of the first and second actions is related to the feeding and nutrition factors and is selected from the group consisting of providing breast milk, providing nutritious complementary foods and beverages at the appropriate developmental stage, excluding sugar sweetened beverages for infants and limiting them for toddlers, or combinations thereof.

In an embodiment, the action is providing breast milk, and the instructing begins in a third trimester of a mother of the child.

In an embodiment, the action is providing nutritious complementary foods and beverages at the appropriate developmental stage, and the instructing begins when the child is about two months of age.

In an embodiment, the action is excluding sugar sweetened beverages for infants and limiting them for toddlers, and the instructing begins when the child is about two months of age.

In an embodiment, at least one of the first and second actions is related to the feeding related behavior factors and is selected from the group consisting of utilizing responsive feeding practices, ensuring that the child has adequate sleep, fostering healthy eating behaviors through shared family meals and mealtime routines, limiting TV and screen viewing time, providing opportunities for physical activity, or combinations thereof.

In an embodiment, the action is utilizing responsive feeding practices, and the instructing begins at birth of the child.

In an embodiment, the action is including the child at family meals, and the instructing begins when the child is about six months of age.

In an embodiment, the action is limiting television and screen viewing time, and the instructing begins when the child is about four months of age.

In an embodiment, the action is ensuring the child has adequate sleep, and the instructing begins when the child is about two months of age.

In an embodiment, the action is providing opportunities for the child to be physically active, and the instructing begins when the child is about four months of age.

In an embodiment, the method further includes providing the caregiver with at least one education tool selected from the group consisting of a menu planner, visuals of serving sizes, breastfeeding tracker, growth tracking tool, or combinations thereof. The at least one education tool may be provided to the caregiver by a media source selected from the group consisting of mailers, email, video, telephone, printed sources, web-related applications, mobile phone applications, computer implemented programs, or combinations thereof.

In an embodiment, the method further includes providing the caregiver with at least one support source selected from the group consisting of a registered dietitian, a certified lactation specialist, or combinations thereof. The caregiver may access the support source using a media source selected from the group consisting of mailers, email, video, telephone, printed sources, web-related applications, mobile phone applications, computer implemented programs, or combinations thereof. In an embodiment, the caregiver accesses the support source using a telephone.

In an embodiment, the method further includes calculating the child's risk of becoming obese by age two using an obesity risk calculator that may be used to calculate a child's risk at any point within a child's first two years of life. The calculator may comprise at least two sub-components: a questionnaire and a science based algorithm for calculating risk.

In an embodiment, the questionnaire includes questions about the caregiver's current level of performing the modifiable risk factors along with basic biological or demographic information of the mother of the child.

In an embodiment, one to all of the modifiable risk factors are assessed, depending on the child's age.

In an embodiment, at least one of the modifiable risk factors assessed in the obesity risk calculator is whether the caregiver chooses to feed the child breast milk and the risk factor is assessed in a third trimester of a mother of the child.

In an embodiment, at least one of the modifiable risk factors assessed in the obesity risk calculator is to what degree sugar sweetened beverages are excluded from the diet for infants and limited for toddlers, and the risk factor is assessed when the child is about two months of age.

In an embodiment, at least one of the modifiable risk factors assessed in the obesity risk calculator is whether the caregiver utilizes responsive feeding practices when caring for the child, and the risk factor is assessed after the birth of the child.

In an embodiment, at least one of the modifiable risk factors assessed in the obesity risk calculator is whether the caregiver fosters healthy eating behaviors through shared family meals and mealtime routines, and the risk factor is assessed when the child is about six months of age.

In an embodiment, at least one of the modifiable risk factors assessed in the obesity risk calculator is to what degree the caregiver limits television and screen viewing time, and the risk factor is assessed when the child is about four months of age.

In an embodiment, at least one of the modifiable risk factors assessed is assessed in the obesity risk calculator is whether the caregiver ensures that the child has adequate sleep, and the risk factor is assessed when the child is about two months of age.

In an embodiment, at least one of the modifiable risk factors assessed is assessed in the obesity risk calculator is to what degree the caregiver provides opportunities for physical activity for the child and the risk factor is assessed when the child is about four months of age.

In an embodiment, the risk of becoming obese by age two is calculated using an obesity risk calculator that assesses a plurality of the following modifiable risk factors: 1) whether the caregiver feeds the child breast milk, 2) whether the caregiver feeds the child using responsive feeding practices, 3) whether the caregiver provides nutritious complementary foods and beverages at the appropriate developmental stage, 4) whether the caregiver ensures that the child has adequate sleep, 5) to what degree the caregiver excludes sugar sweetened beverages for infants and limits them for toddlers, 6) whether the caregiver fosters healthy eating behaviors through shared family meals and mealtime routines, 7) how much time the caregiver allows the child to spend watching TV or having other screen viewing time, 8) and to what degree the caregiver provides opportunities for physical activity for the child.

In an embodiment, the calculator can generate the child's percent chance of becoming obese, as well as specific risk levels for each factor associated with childhood obesity.

In yet another embodiment, a method for calculating a child's risk of becoming obese within the first two years of age is provided. The method includes instructing a child's caregiver to answer a questionnaire including background information about the child and information relating to modifiable risk factors associated with obesity. The answers are then input into a science based algorithm that generates the child's percent chance of becoming overweight or obese within the first two years of age. It also generates the specific risk for the child from each modifiable risk factor for obesity.

In an embodiment, the caregiver is a health care provider.

In still yet another embodiment, a method improving obesity-related medical care for children by calculating a child's risk of becoming obese within the first two years of age is provided. The method includes instructing a child's caregiver to answer a questionnaire including basic biological or demographic information about the child and information relating to the caregiver's current level of performing modifiable risk factors associated with childhood obesity, inputting the answers from the questionnaire into a science-based algorithm, calculating the child's percent chance of becoming overweight or obese within the first two years of age, and calculating the specific risk for the child from each modifiable risk factor. A risk report including the percent chance of becoming overweight or obese and the specific risks from each factor is generated and distributed to the child's caregiver and health care providers involved in the care of the child.

In yet another embodiment, a method for improving patient counseling on childhood obesity for patients in need of the same is provided. The method includes instructing a child's caregiver to answer a questionnaire including basic biological or demographic information about the child and information relating to the caregiver's current level of performing modifiable risk factors associated with childhood obesity. The answers are then input from the questionnaire into a science-based algorithm and the child's percent chance of becoming overweight or obese within the first two years of age as well as the specific risk for the child from each modifiable risk factor is generated. The method also includes displaying the child's percent chance of becoming obese and the specific risks from each factor through a source selected from the group consisting of electronic message; printed report; printed graphic; text message; phone call; web related application; computer implemented program; mobile phone application; or combinations thereof.

In an embodiment, the method may be used to calculate a child's risk at any point within a child's first two years of life.

In an embodiment, one to all of the modifiable risk factors may be assessed, depending on the child's age.

In an embodiment, at least one of the modifiable risk factors assessed in an obesity risk calculation is whether the caregiver chooses to feed the child breast milk and the risk factor is assessed in a third trimester of a mother of the child.

In an embodiment, at least one of the modifiable risk factors assessed in an obesity risk calculation is to what degree sugar sweetened beverages are excluded from the diet for infants and limited for toddlers, and the risk factor is assessed when the child is about two months of age.

In an embodiment, at least one of the modifiable risk factors assessed in an obesity risk calculation is whether the caregiver utilizes responsive feeding practices when caring for the child, and the risk factor is assessed after the birth of the child.

In an embodiment, at least one of the modifiable risk factors assessed in an obesity risk calculation is whether the caregiver fosters healthy eating behaviors through shared family meals and mealtime routines, and the risk factor is assessed when the child is about six months of age.

In an embodiment, at least one of the modifiable risk factors assessed in an obesity risk calculation is to what degree the caregiver limits television and screen viewing time, and the risk factor is assessed when the child is about four months of age.

In an embodiment, at least one of the modifiable risk factors assessed is assessed in an obesity risk calculation is whether the caregiver ensures that the child has adequate sleep, and the risk factor is assessed when the child is about two months of age.

In an embodiment, at least one of the modifiable risk factors assessed is assessed in an obesity risk calculation is to what degree the caregiver provides opportunities for physical activity for the child and the risk factor is assessed when the child is about four months of age.

In an embodiment, the risk of becoming obese by age two is calculated in an obesity risk calculation that assesses a plurality of the following modifiable risk factors: 1) whether the caregiver feeds the child breast milk, 2) whether the caregiver

In an embodiment, the method further includes generating a personalized behavioral guidance/counseling plan based on the obesity risks. In an embodiment, the plan is provided to any health care professionals involved in the care of the child.

In still yet another embodiment, a computer implemented method of reducing childhood obesity within the first two years of age is provided. The method includes collecting basic biological or demographic information about a child from the child's caregiver and collecting information relating to the caregiver's current level of performing modifiable risk factors associated with childhood obesity. The information is then input into a computer implemented program and processed on a computer processor using a science-based algorithm. The child's percent chance of becoming overweight or obese within the first two years of age and the specific risk for the child from each modifiable risk factor using the algorithm is calculated and a behavioral guidance plan for the child's caregiver optimized to the child's calculated percent chance of becoming overweight or obese and the child's specific risk level from the modifiable factors is generated.

In an embodiment, only one algorithm is used.

In an embodiment, the method may be used to calculate a child's risk at any point within a child's first two years of life.

In an embodiment, one to all of the modifiable risk factors may be assessed, depending on the child's age.

In an embodiment, at least one of the modifiable risk factors assessed in an obesity risk calculation is whether the caregiver chooses to feed the child breast milk and the risk factor is assessed in a third trimester of a mother of the child.

In an embodiment, at least one of the modifiable risk factors assessed in an obesity risk calculation is to what degree sugar sweetened beverages are excluded from the diet for infants and limited for toddlers, and the risk factor is assessed when the child is about two months of age.

In an embodiment, at least one of the modifiable risk factors assessed in an obesity risk calculation is whether the caregiver utilizes responsive feeding practices when caring for the child, and the risk factor is assessed after the birth of the child.

In an embodiment, at least one of the modifiable risk factors assessed in an obesity risk calculation is whether the caregiver fosters healthy eating behaviors through shared family meals and mealtime routines, and the risk factor is assessed when the child is about six months of age.

In an embodiment, at least one of the modifiable risk factors assessed in an obesity risk calculation is to what degree the caregiver limits television and screen viewing time, and the risk factor is assessed when the child is about four months of age.

In an embodiment, at least one of the modifiable risk factors assessed is assessed in an obesity risk calculation is whether the caregiver ensures that the child has adequate sleep, and the risk factor is assessed when the child is about two months of age.

In an embodiment, at least one of the modifiable risk factors assessed is assessed in an obesity risk calculation is to what degree the caregiver provides opportunities for physical activity for the child and the risk factor is assessed when the child is about four months of age.

In an embodiment, the risk of becoming obese by age two is calculated in an obesity risk calculation that assesses a plurality of the following modifiable risk factors: 1) whether the caregiver feeds the child breast milk, 2) whether the caregiver feeds the child using responsive feeding practices, 3) whether the caregiver provides nutritious complementary foods and beverages at the appropriate developmental stage, 4) whether the caregiver ensures that the child has adequate sleep, 5) to what degree the caregiver excludes sugar sweetened beverages for infants and limits them for toddlers, 6) whether the caregiver fosters healthy eating behaviors through shared family meals and mealtime routines, 7) how much time the caregiver allows the child to spend watching TV or having other screen viewing time, 8) and to what degree the caregiver provides opportunities for physical activity for the child.

In an embodiment, the behavioral guidance program includes educational content, tools, support services, and calculation of obesity risk at regular intervals.

In an embodiment, the behavioral guidance program is modified based on changes in the child's calculated percent chance of becoming overweight or obese and the child's specific risk level from the modifiable factors.

In an embodiment, the caregiver is the biological mother of the child and a first-time mother. In an embodiment, the caregiver is not the biological mother of the child. In an embodiment wherein the caregiver is not the biological mother, every message disclosed herein may not be applicable to the caregiver (e.g., “provide breastmilk”).

In an embodiment, the delivery may begin in the mother's third trimester and last at least two years. Alternatively, delivery may begin after the child is born.

In an embodiment, the non face-to-face method of communication is a media source selected from the group consisting of selected from the group consisting of mailers, email, video, telephone, printed sources, web-related applications, mobile phone applications, computer implemented programs, or combinations thereof. In an embodiment, the media source is a website.

In an embodiment, the plurality of messages includes at least 3, 4, 5, 6, 7, 8, or more messages. The messages may relate to the factors selected from the group consisting of feeding and nutrition, feeding related behavior, or combinations thereof. At least one of the plurality of messages may be related to the feeding and nutrition factors and may be selected from the group consisting of “provide breast milk,” “provide nutritious complementary foods and beverages at the appropriate developmental stage,” “exclude sugar sweetened beverages for infants and limit them for toddlers,” or combinations thereof.

In an embodiment, the message is “provide breast milk,” and the message is first delivered to the caregiver in a third trimester of a mother of the child.

In an embodiment, the message is “provide nutritious complementary foods and beverages at the appropriate developmental stage,” and the message is first delivered to the caregiver when the child is about two months of age.

In an embodiment, the message is “exclude sugar sweetened beverages for infants and limit them for toddlers,” and the message is first delivered to the caregiver when the child is about two months of age.

In an embodiment, at least one of the plurality of messages is related to the feeding related behavior factors and is selected from the group consisting of “utilize responsive feeding practices,” “ensure that the child has adequate sleep,” “foster healthy eating behaviors through shared family meals and mealtime routines,” “limit TV and screen viewing time,” “provide opportunities for physical activity,” or combinations thereof.

In an embodiment, the message is “utilize responsive feeding practices,” and the message is first delivered to the caregiver at birth of the child.

In an embodiment, the message is “foster healthy eating behaviors through shared family meals and mealtime routines,” and the message is first delivered to the caregiver when the child is about six months of age.

In an embodiment, the message is “limit television and screen viewing time,” and the message is first delivered to the caregiver when the child is about four months of age.

In an embodiment, the message is “ensure that the child has adequate sleep,” and the message is first delivered to the caregiver when the child is about two months of age.

In an embodiment, the message is “provide opportunities for physical activity,” and the message is first delivered to the caregiver when the child is about four months of age.

In an embodiment, the developmental stage is selected from the group consisting of birth+, supported sitter, sitter, crawler, toddler, preschooler, or combinations thereof. The birth+ developmental stage typically occurs between zero and four months. The supported sitter developmental stage typically occurs between four and six months. The sitter developmental stage typically occurs after about six months. The crawler developmental stage typically occurs after about eight months.

In an embodiment, the method further includes providing the caregiver with at least one education tool selected from the group consisting of a menu planner, visuals of serving sizes, breastfeeding tracker, growth tracking tools, or combinations thereof. The at least one education tool may be provided to the caregiver by a media source selected from the group consisting of mailers, email, video, telephone, printed sources, web-related applications, mobile phone applications, computer implemented programs, or combinations thereof.

In an embodiment, the method further includes providing the caregiver with at least one support source selected from the group consisting of a registered dietitian, a certified lactation specialist, or combinations thereof. The caregiver may access the at least one support source using a media source selected from the group consisting of mailers, email, video, telephone, printed sources, web-related applications, mobile phone applications, computer implemented programs, or combinations thereof. In an embodiment, the caregiver may access the support source using a telephone.

It is an advantage of the present disclosure to provide methods for calculation risk of obesity.

It is an advantage of the present disclosure that the obesity risk calculator can be used by caregivers to mitigate risk of obesity for children under two years of age.

It is an advantage of the present disclosure that the obesity risk calculator can be independently used by health care providers to improve patient counseling and to individualize care.

It is an advantage of the present disclosure to provide methods for reducing childhood obesity.

It is another advantage of the present disclosure to provide a multi-component feeding method and obesity risk calculator that aid in reducing childhood obesity.

It is yet another advantage of the present disclosure to provide a multi-component feeding method based on calculated obesity risk that can be delivered by any public health program.

It is still yet another advantage of the present disclosure to provide a multi-component feeding method based on calculated obesity risk that can be delivered to any literate population group (e.g., race/ethnicity, SES status). In an embodiment, the population group may be an English speaking population group.

It is another advantage of the present disclosure to lower the body mass index (“BMI”), rate of weight gain, and weight of children in the first two years of a child's life.

It is yet another advantage of the present disclosure to develop positive feeding practices and feeding-related practices in the first two years of a child's life.

It is another advantage of the present disclosure to provide increased initiation rates and duration of breastfeeding.

It is yet another advantage of the present disclosure to provide improved diet quality.

It is still yet another advantage of the present disclosure to provide increased knowledge of a parent with respect to infant and child diet and feeding behaviors.

Additional features and advantages are described herein, and will be apparent from the following Detailed Description and the figures.

### BRIEF DESCRIPTION OF THE FIGURES

FIG. 1 illustrates the prevalence of high weight-for-recumbent length (birth to 2 years) and Body Mass Index (“BMI”) (2 to 19 years) among United States Children National Health and Nutrition Examination Survey 2007-2008. Adapted from Ogden, C. L., et al., “Prevalence of High Body Mass Index in US Children and Adolescents,” JAMA, 303:242-249 (2010).

FIG. 2 illustrates percentages of children consuming breast milk. Adapted from Siega-Riz et al., “Food Consumption Patterns of Infants and Toddlers: Where Are We Now”?, J. Am. Diet. Assoc., 110:S38-S51 (2010).

FIG. 3 illustrates average energy (kcal/day) intakes: FITS 2008 compared to Estimated Energy Requirements from Birth to 35 Months of Age. Estimated Energy Requirements based on Centers for Disease Control and Prevention median weights. Kuczmarski et al., CDC growth charts: United States. Advance data from vital and health statistics; No. 314. National Center for Health Statistics, http://www.cdc.gov/nchs/data/ad/ad314.pdf (2000). Preliminary data presented at the American Dietetic Association Annual Meeting (2009).

FIG. 4 illustrates percentages of children consuming various complementary foods from birth to 15 months of age. FITS 2008. Adapted from Siega-Riz et al., “Food Consumption Patterns of Infants and Toddlers: Where Are We Now”?, J. Am. Diet. Assoc., 110:S38-S51 (2010).

FIG. 5 illustrates percentages of infants and toddlers consuming various vegetables at least once a day. FITS 2008. Adapted from Siega-Riz et al., “Food Consumption Patterns of Infants and Toddlers: Where Are We Now”?, J. Am. Diet. Assoc., 110:S38-S51 (2010).

FIG. 6 illustrates percentages of infants and toddlers consuming various fruits or 100% fruit juice at least once a day. FITS 2008. Adapted from Siega-Riz et al., “Food Consumption Patterns of Infants and Toddlers: Where Are We Now”?, J. Am. Diet. Assoc., 110:S38-S51 (2010).

### DETAILED DESCRIPTION

### Definitions

As used herein, “anticipatory” means that messages or instructions are initially provided to a caregiver in advance of, or before, a child's relevant developmental stage. For example, a message to a caregiver may be “breastfeed your baby.” During a mother's third trimester, the fetus has not yet reached a developmental stage (e.g., birth) wherein the baby requires feedings (e.g., breastfeeding, bottle feeding, etc.). As such, if the message is delivered to a first-time mother during the mother's third trimester, the message is anticipatory of the child's relevant developmental stage (e.g., birth+, when the child requires feedings). Although the message are initially (e.g., for a first time) provided to a caregiver in advance of, or before, a child's relevant developmental stage, the messages or instructions provided to the caregiver may continue to be delivered after the first delivery.

As used herein, “sequential” or “sequentially” means that messages or instructions are initially (e.g., for a first time) provided to a caregiver in a successive manner with respect to a child's relevant developmental stage. For example, a message to “breastfeed your baby” may be given to a first-time mother during her third trimester in anticipation of the birth of the child, and a message to “introduce your baby to solid foods” may be given to a first-time mother when the child is about two months of age, in anticipation of introduction of solid foods to the child at an age of about four to six months. Thus, the messages are initiated sequentially with respect to the child's relevant developmental stages, even though the message may continue to be provided to the caregiver after the first provision of same.

As used herein, “developmental stage” or “developmental stages” refer to a stage in a child's life where children typically begin to exhibit certain behaviors or are typically capable of performing certain actions. For example, solid foods are typically introduced to a child in a “supported sitter” stage, which may be from about four to about six months. Other examples of developmental stages include “birth+” at about zero to about four months, “sitter” at about six+ months, “crawler” at about eight+ months, “toddler” at about twelve+ months, and “preschooler” at about 24+ months.

As used herein, “obesity” refers to a condition in which the natural energy reserve, stored in the fatty tissue of animals, in particular humans and other mammals, is increased to a point where there is increase in adiposity and it is associated with certain health conditions or increased mortality.

As used herein, “overweight” refers to a condition in which the natural energy reserve, stored in the fatty tissue of animals, in particular humans and other mammals is increased. “Overweight” may be associated with an increase in adiposity and certain health conditions or increased mortality.

As used herein, a “message” or “instruction” means an assembly of information relating to core feeding (e.g., feeding and nutrition factors, feeding related behavior factors), feeding strategies, and practical parent feeding suggestions that are associated with a healthy diet and prevention of childhood obesity based on modifiable factors associated with obesity.

Prevalence of Infant and Childhood Obesity

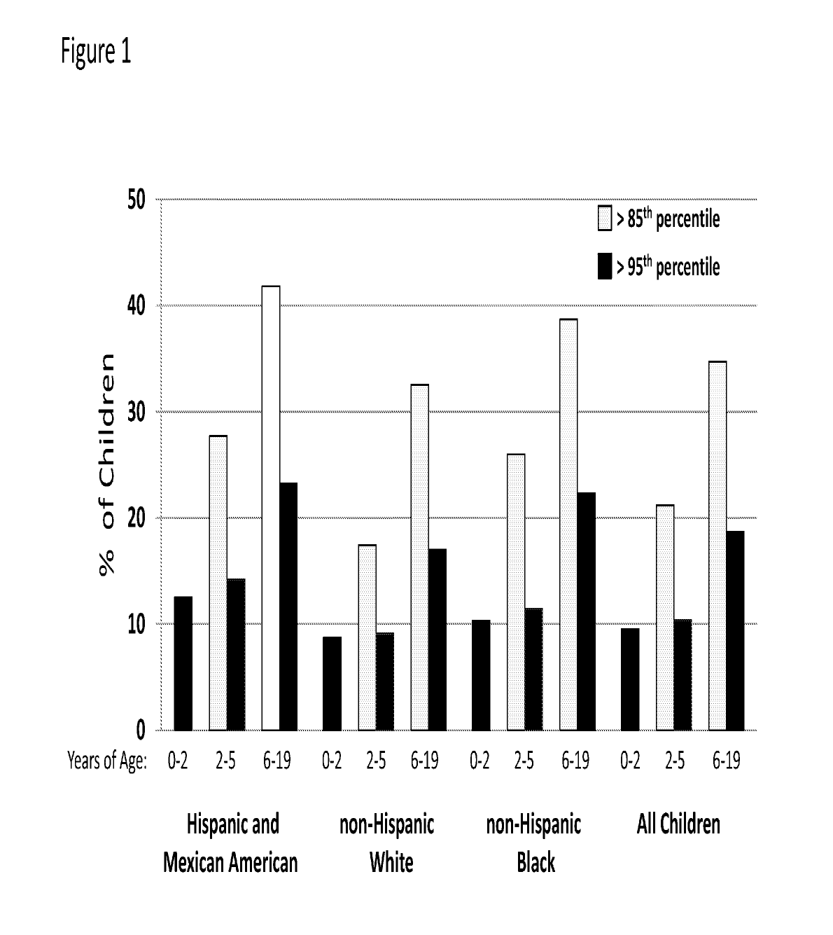

Childhood obesity is a global epidemic and has become one of the most prominent and challenging public health concerns in the US today. Since the 1970's the increasing prevalence of obesity in children has continued unabated, until recently, when after tripling over a 35 year period among school-age children, rates appear to have stabilized. Broyles S., et al., “The Pediatric Obesity Epidemic Continues Unabated in Bogalusa, La.,” Pediatrics; 125:900-5 (2010). Recent US national survey data indicates that nearly one-third of American children meet criteria for a diagnosis of overweight (≧85^{th} body mass index (BMI) percentile for age) and 17% are obese (≧95^{th} percentile). Ogden C. L., et al., “Prevalence of high body mass index in US children and adolescents,” JAMA, 303:242-9, 2007-2008 (2010). Rates of overweight and obesity are disproportionately associated with some race and ethnic groups, and appear consistent throughout infancy and childhood. As is shown in FIG. 1, Hispanic and Mexican American's and non-Hispanic Black children are burdened with a higher prevalence of overweight and obesity from infancy through 19 years of age, compared to other groups.

Children are becoming affected with excess weight at young ages. Worldwide, an estimated twenty-two million children under five years of age were overweight in 2007, see, Lanigan J., et al., “Prevention of obesity in preschool children,” Proc. Nutr. Soc.; 69:204-10 (2010), and recent US national survey data indicate that one in five children age 2-5 years old are overweight; 10% of US preschool age children are obese. Equally concerning is the finding that nearly 10% of US infants and toddlers, from birth to two years of age are also obese, at or above the 95^{th} percentile of the weight for recumbent length growth charts. Ogden C. L., et al., “Prevalence of high body mass index in US children and adolescents,” JAMA, 303:242-9, 2007-2008 (2010). More than half the overweight children from one longitudinal study became overweight before age two, and 25% were overweight by five months of age. Harrington J. W., et al., “Identifying the ‘Tipping Point’ Age for Overweight Pediatric Patients,” Clin. Pediatr. (Phila.) (2010).

Health and Economic Consequences of Childhood Obesity

Overweight infants and children are not immune to the increased risk of disease that often coexists among overweight adults. An alarming increasing prevalence among overweight children with (i) insulin resistance and Type II diabetes mellitus, see, Boney C. M., et al., “Metabolic syndrome in childhood: association with birth weight, maternal obesity, and gestational diabetes mellitus,” Pediatrics, 115:e290-e296, (2005); Lobstein T., et al., “Estimated burden of paediatric obesity and co-morbidities in Europe. Part 2. Numbers of children with indicators of obesity-related disease,” Int. J. Pediatr. Obes., 1:33-41 (2006); Huang T. T., et al., “Metabolic syndrome in youth: current issues and challenges,” Appl. Physiol. Nutr. Metab., 32:13-22 (2007); Kaufman F. R., “Type 2 diabetes mellitus in children and youth: a new epidemic,” J. Pediatr. Endocrinol. Metab., 15 Suppl 2:737-44 (2002); Franks P. W., et al., “Childhood predictors of young-onset type 2 diabetes,” Diabetes, 56:2964-72, (2007); (ii) dyslipidemia, see, Freedman D. S., et al, “Relationship of childhood obesity to coronary heart disease risk factors in adulthood: the Bogalusa Heart Study,” Pediatrics, 108:712-8 (2001); Freedman D. S., et al., “The relation of overweight to cardiovascular risk factors among children and adolescents: the Bogalusa Heart Study,” Pediatrics, 103:1175-82 (1999); (iii) hypertension, see, Freedman D. S., et al., “Relationship of childhood obesity to coronary heart disease risk factors in adulthood: the Bogalusa Heart Study,” Pediatrics, 108:712-8 (2001); Sorof J. M., et al., “Overweight, ethnicity, and the prevalence of hypertension in school-aged children,” Pediatrics, 113:475-82 (2004); and (iv) elevated circulating inflammatory markers, see, Tam C. S., et al., “Obesity and low-grade inflammation: a paediatric perspective,” Obes. Rev., 11:118-26 (2010); Skinner A. C., et al., “Multiple markers of inflammation and weight status: cross-sectional analyses throughout childhood,” Pediatrics, 125:e801-e809 (2010) have been identified. Obese children are also more likely to have increased risk of heart disease, see, Daniels S. R., et al., “Overweight in children and adolescents: pathophysiology, consequences, prevention, and treatment,” Circulation 2005; 111:1999-2012, and recent research has provided evidence of altered adipocyte morphology and inflammatory processes in adipose tissue of obese children, similar to those in adults, as early as three years. Tam C. S., et al., “Obesity and low-grade inflammation: a paediatric perspective,” Obes. Rev., 11:118-26 (2010); Kapiotis S., et al., “A proinflammatory state is detectable in obese children and is accompanied by functional and morphological vascular changes,” Arterioscler. Thromb. Vasc. Biol., 26:2541-6, (2006); Lande M. B., et al., “Elevated blood pressure, race/ethnicity, and C-reactive protein levels in children and adolescents,” Pediatrics, 122:1252-7 (2008); Skinner A. C., et al., “Multiple markers of inflammation and weight status: cross-sectional analyses throughout childhood,” Pediatrics, 125:e801-e809 (2010). Although it remains to be determined whether elevated levels of inflammatory markers in obese children predicts later cardiovascular events, it is biologically plausible that an increased length of exposure to an inflammatory state could increase the risk of vascular damage in later years. Id.

The impact of medical costs associated with childhood obesity has significant short and long term financial consequences. A recent review of studies providing estimates of the economic impact of obesity in the US concluded that on a nationwide basis, excess medical spending may reach as much as $14.3 billion annually for obese children, and up to $147 billion for obese adults. Hammond, R. A. et al., “The economic impact of obesity in the United States. Diabetes, Metabolic Syndrome and Obesity: Targets and Therapy 3,” 285-295 (2010). In addition, through mathematical modeling techniques, Trasande estimated that an overweight boy in the US, age 12 years in 2005, would incur an estimated $700 million in direct medical expenditures during childhood attributable to his overweight status, and $718 million if he were obese. Trasande L., “How much should we invest in preventing childhood obesity”?, Health Aff. (Millwood), 29:372-8 (2010). A predicted $3.5 billion in additional medical expense would be spent by an adult if he was overweight or obese as a child. However, with a 1% decrease in overweight among 12 year olds, $87.7 million could be saved during childhood, and $40.0 million worth of medical expenditures could be reduced in adulthood. Id.

Obesity During Infancy Predicts Adult Weight

Many overweight infants remain overweight into their childhood years, and childhood obesity has long been known as a strong predictor of adult obesity. Whitaker R. C., et al., “Predicting obesity in young adulthood from childhood and parental obesity,” N. Engl. J. Med., 337:869-73 (1997). Results from a retrospective medical-chart review of 257 children demonstrated that an increased BMI, as early as two weeks of age, was associated with a significant increased risk of overweight at 6, 12, 36, and 60 months. Winter J. D., et al., “Newborn adiposity by body mass index predicts childhood overweight,” Clin. Pediatr. (Phila), 49:866-70 (2010). Similarly, reports of overweight at 6-18 months of age being strongly predictive of weight in preschool years are becoming more often documented. Ohlund I, et al., “BMI at 4 years of age is associated with previous and current protein intake and with paternal BMI,” Eur. J. Clin. Nutr., 64:138-45 (2010); Taveras E. M., et al., “Weight status in the first 6 months of life and obesity at 3 years of age,” Pediatrics, 123:1177-83 (2009); Stettler N., et al., “Early growth patterns and long-term obesity risk,” Curr. Opin. Clin. Nutr. Metab. Care, 13:294-9 (2010). Recent longitudinal data from 762 infants and children (age 0-18 yrs) indicated that body weight as early as age two begins a positive tracking period for adult overweight; weight status from 2-6 years was the most critical growth period for prediction and realization of adult overweight. De Kroon M. L., et al., “The Terneuzen birth cohort: BMI changes between 2 and 6 years correlate strongest with adult overweight,” PLoS One, 5:e9155 (2010). An overweight child at age 2-4 years has a 5-fold increased risk of being overweight at age 12, compared to children not overweight during their pre-school years. Stunkard A. J., et al., “The body-mass index of twins who have been reared apart,” N. Engl. J. Med., 322:1483-7 (1990). The earlier a child becomes overweight, and the longer excess weight is maintained, the greater the risk that the child's overweight will follow into adulthood.

The increasing prevalence of obesity in infants and its long term consequences, not only adds to the gravity of the problem, but also points to the necessity, as well as the potential for interventions which focus on this age group. In fact, given the apparent ontogenetic progression of this condition, the metabolic programming plasticity, and the behavioral modeling pliability of infancy, this may be the most critical and potentially efficacious window of opportunity available for true “prevention” or reduction of obesity in the general population.

Factors Associated with Childhood Obesity and Potential Causality

Antecedents of early childhood obesity are clearly multifactorial, and associations of varying strength have been documented for genetic, biologic, dietary, environmental, social, and behavioral, factors. However, eight factors have been identified as modifiable factors, meaning that they can be affected and by affecting the factors, obesity risk can be modulated.

Genetic Factors

Although strong evidence supports the role of yet non-modifiable genetic factors in early-onset obesity, in and by themselves, these appear as an insufficient argument to support the increased prevalence in childhood obesity over the last three decades. Genetic polymorphisms that increase the risk for obesity may explain a small fraction of cases of childhood-onset obesity. Stunkard A J.., “The body-mass index of twins who have been reared apart,” N. Engl. J. Med., 322:1483-7 (1990); Scherag A., et al., “Two new Loci for body-weight regulation identified in a joint analysis of genome-wide association studies for early-onset extreme obesity in French and german study groups,” PLoS Genet, 6:e1000916 (2010); Bell C. G., et al., “The genetics of human obesity,” Nat. Rev. Genet., 6:221-34 (2005); Chung W. K., et al., “Molecular physiology of syndromic obesities in humans,” Trends Endocrinol. Metab., 16:267-72 (2005). However, in the majority children, obesity is attributed to the interaction between multiple genetic factors and an accommodating environment, see, Mutch D M, et al., “Genetics of human obesity,” Best Pract. Res. Clin. Endocrinol Metab., 20:647-64 (2006), of which is just recently beginning to be studied, see, Trasande L., et al., “Environment and obesity in the National Children's Study, “Environ Health Perspect., 117:159-66 (2009). Integration of data from multiple sources of environment, genotype, and expression will help clarify obesity related contributions from these areas.

Genetic predisposition is a non-modifiable factor, but it in itself is insufficient to explain all incidence of childhood obesity. Genetic predispositions related to children's weight, food intake, and dietary patterns are modulated by experience, see, Scaglioni S., et al., “Influence of parental attitudes in the development of children eating behaviour,” Br. J. Nutr., 99 Suppl 1:S22-S25 (2008), and significantly influenced by the environment, including the family environment, see, Wardle J., et al., “Genetic and environmental determinants of children's food preferences,” Br. J. Nutr., 99 Suppl 1:S15-S21 (2008). Skidmore and colleagues recently suggested that an obesogenic postnatal environment is more important than the fetal environment for the development of obesity in female twins. Skidmore P. M., et al., “An obesogenic postnatal environment is more important than the fetal environment for the development of adult adiposity: a study of female twins,” Am. J. Clin. Nutr., 90:401-6 (2009). Even racial and ethnic differences in the prevalence of pediatric obesity may be partly explained by differences in potentially modifiable risk factors during early infancy. Taveras E. M., et al., “Racial/ethnic differences in early-life risk factors for childhood obesity,” Pediatrics; 125, 686-95 (2010).

Not surprisingly, parental weight status is a strong predictor of childhood obesity, as parents provide genes, environment, and a diet, within a context of their particular social and behavioral settings. Children of overweight parents are at increased risk for development of obesity, and although findings of an independent association with paternal weight and childhood weight status have been demonstrated, maternal weight status is consistently reported as one of the strongest correlations with their children's weight. Whitaker R. C., et al., “Predicting obesity in young adulthood from childhood and parental obesity,” N. Engl. J. Med., 337:869-73 (1997); Price R. A., et al., “Childhood onset (age less than 10) obesity has high familial risk,” Int. J. Obes., 14:185-95 (1990); Ohlund I., et al., “BMI at 4 years of age is associated with previous and current protein intake and with paternal BMI,” Eur. J. Clin. Nutr., 64:138-45 (2010). Children of overweight mothers are nearly three times as likely to be overweight as children born from mothers of a healthy weight. Danielzik, S., et al., “Impact of parental BMI on the manifestation of overweight 5-7 year old children,” Eur. J. Nutr., 41:132-138 (2002). Obese women tend to have large babies, and large for their gestational age babies are at a higher risk of becoming obese children, though not all studies have confirmed this association. Salihu H. M., et al., “Success of programming fetal growth phenotypes among obese women,” Obstet. Gynecol., 114:333-9 (2009); Stettler N., et al., “Early growth patterns and long-term obesity risk,” Curr. Opin. Clin. Nutr. Metab. Care, 13:294-9 (2010). In sum, genetic relationships are clearly associated with childhood obesity, but cannot explain all cases of childhood overweight or obesity. Increasingly, it appears that epigenetic factors, those other than inherited shifts in phenotype or gene expression related to changes in DNA sequence, may better link the association between obesity and genes.

Prenatal Environment

It has long been recognized that prenatal exposure to maternal smoking during pregnancy increases risk for later obesity, and meta-analyses results confirmed that children whose mothers smoked during pregnancy were at elevated risk for overweight (pooled adjusted odds ratio (“OR”) 1.50, 95% CI: 1.36, 1.65) at ages 3-33 years, compared with children whose mothers did not smoke during pregnancy. Oken E., et al., “Maternal smoking during pregnancy and child overweight: systematic review and meta-analysis,” Int. J. Obes. (Lond), 32:201-10 (2008). Prenatal exposure to other environmental toxins that may increase the risk of childhood obesity, such as endocrine disrupting chemicals, are gaining attention as potential prenatal obesogenic factors. Newbold R. R., et al., “Developmental exposure to endocrine disruptors and the obesity epidemic,” Reprod. Toxicol., 23:290-6 (2007). As proposed within the National Children's Study, additional chemicals and compounds will be investigated as correlates to early weight; results are pending. Trasande L., et al., “Environment and obesity in the National Children's Study,” Environ. Health Perspect., 117:159-66 (2009); Landrigan P. J., et al., “The National Children's Study: a 21-year prospective study of 100,000 American children,” Pediatrics, 118:2173-86 (2006).

The intrauterine environment may also be a viable source of extra macronutrients that influence birth weight. Infants that experience excess maternal gestational weight gain in utero, or who are born to mothers with diabetes, have an increased risk of being born large for their gestational age. These infants will also have a greater risk of becoming overweight, or of developing increased adiposity during their preschool, or school age years. Gillman M. W., et al., “Developmental origins of childhood overweight: potential public health impact,” Obesity (Silver Spring), 16:1651-6 (2008); Oken E., et al, “Gestational weight gain and child adiposity at age 3 years,” Am. J. Obstet. Gynecol., 196:322-8 (2007); Lewis K. L., et al., “Overweight among low-income Texas preschoolers aged 2 to 4 years,” J. Nutr. Educ. Behav., 42:178-84 (2010); Wright C. S., et al., “Intrauterine exposure to gestational diabetes, child adiposity, and blood pressure,” Am. J. Hypertens., 22:215-20 (2009); Oken E., et al., “Maternal gestational weight gain and offspring weight in adolescence,” Obstet. Gynecol., 112:999-1006 (2008); Wrotniak B. H., “Gestational weight gain and risk of overweight in the offspring at age 7 y in a multicenter, multiethnic cohort study,” Am. J. Clin. Nutr., 87:1818-24 (2008); Lamb M. M., et al., “Early-life predictors of higher body mass index in healthy children,” Ann. Nutr. Metab., 56:16-22 (2010).

Although associations from observational studies described above are generally consistent with regard to infant or childhood risk of excess weight, causality has not unequivocally been established. Nevertheless, these strong associations underscore the fact that maternal obesity, along with its attendant endocrine and other biologic disruptions may contribute to a generational perpetuation of the problem, and argues for the potential of prenatal interventions to modify the fetal environment. While meritorious, it also appears clear that if modification of maternal dietary and environmental interventions were to be attempted, some of these potential preventive measures would need to begin prior to gestation. Parental weight (and particularly maternal weight's) effect on childhood obesity clearly emphasizes the need to for a method to alert parents to obesity risk and provide an effective plan to modulate that risk.

Weight Gain During Infancy

Results from several systematic reviews are consistent in demonstrating strong evidence of a positive association between rapid infancy weight gain and later risk of obesity. Stettler N., et al., “Early growth patterns and long-term obesity risk,” Curr. Opin. Clin. Nutr. Metab. Care, 13:294-9 (2010); Ong K. K., et al., “Rapid infancy weight gain and subsequent obesity: systematic reviews and hopeful suggestions,” Acta. Paediatr., 95:904-8 (2006); Baird J., et al., “Being big or growing fast: systematic review of size and growth in infancy and later obesity,” BMJ, 331:929 (2005). Of several body composition methods employed, or surrogate markers used for adiposity estimation, the association among rapid weight gain in infancy and later risk of overweight remained constant. Gillman M. W., et al., “Developmental origins of childhood overweight: potential public health impact,” Obesity (Silver Spring), 16:1651-6 (2008); Reilly J. J., et al., “Early life risk factors for obesity in childhood: cohort study,” BMJ, 330:1357 (2005); Gillman M. W., “The first months of life: a critical period for development of obesity,” Am. J. Clin. Nutr., 87:1587-9 (2008); Gardner D. S., et al., “Contribution of early weight gain to childhood overweight and metabolic health: a longitudinal study (EarlyBird 36),” Pediatrics, 123:e67-e73 (2009); Dubois L., et al., “Early determinants of overweight at 4.5 years in a population-based longitudinal study,” Int. J. Obes. (Lond), 30:610-7 (2006). For example, weight gain during the first two months of life, and from two to nine months measured by dual-energy X-ray absorptiometry, was recently demonstrated to be associated with fat mass, percentage of fat mass, and fat-free mass ratio in ten year old children. Ong K. K., et al., “Infancy weight gain predicts childhood body fat and age at menarche in girls,” J. Clin. Endocrinol. Metab. 94:1527-32 (2009). Similarly, weight gain during the first three months of life, and between three and twelve months, was also positively correlated with World Health Organization BMI z-scores at age seven. Hui L. L., et al., “Birth weight, infant growth, and childhood body mass index: Hong Kong's children of 1997 birth cohort,” Arch. Pediatr. Adolesc. Med., 162:212-8 (2008). Additionally, changes in weight-for-length during the first six months of life were positively associated with BMI, subcutaneous adiposity and obesity at three years of age. Taveras E. M., et al., “Weight status in the first 6 months of life and obesity at 3 years of age,” Pediatrics, 123:1177-83 (2009). Studies with (i) skinfold thickness measurements, see, Karaolis-Danckert N., et al., “How pre- and postnatal risk factors modify the effect of rapid weight gain in infancy and early childhood on subsequent fat mass development: results from the Multicenter Allergy Study 90,” Am. J. Clin. Nutr., 87:1356-64 (2008); (ii) bioimpedance, see, Eriksson M., et al., “Associations of birthweight and infant growth with body composition at age 15—the COMPASS study,” Paediatr. Perinat. Epidemiol., 22:379-88 (2008); Botton J., et al., “Postnatal weight and height growth velocities at different ages between birth and 5 y and body composition in adolescent boys and girls,” Am. J. Clin. Nutr., 87:1760-8 (2008); or (iii) a combination of methods, see, Chomtho S., et al., “Associations between birth weight and later body composition: evidence from the 4-component model,” Am. J. Clin. Nutr., 88:1040-8 (2008); Chomtho S., et al., “Infant growth and later body composition: evidence from the 4-component model,” Am. J. Clin. Nutr., 87:1776-84 (2008); reveal similar findings that early growth patterns are critical periods for development of obesity in infancy. The more rapid and earlier an infant gains excess weight, the greater the likelihood for undesirable weight in subsequent months, and years. Thus, rapid weight gain in early infancy could be considered an “effect” of obesogenic factors in early life, and clearly signals the need for intervening in this period of life.

Potentially Modifiable Feeding and Related Behaviors in Infancy Associated to Childhood Obesity

Designing efficacious interventions for obesity prevention and/or reduction in infancy and young children should be extensions of previously employed successful approaches. When limited research establishing a causal relationship is available, proposed interventions can reasonably be based on factors with strong association to obesity from published observational research. Prospective interventions addressing such associations have a theoretically plausible chance of establishing a causal relationship to the problem. Therefore, the design of a successful preventative intervention should include components that address actionable and potentially modifiable factors associated to the desired outcome. The success of the intervention will also be closely tied to an awareness of a specific child's obesity risk, and the ability of the methods to be tailored and personalized to that individual.

Recent research has brought attention to specific parental feeding practices and behaviors, commencing at birth that may interact with genetic predispositions or prenatal covariates to inadvertently promote an obesogenic environment during infancy. These risk factors associated with overweight or obesity in infancy through preschool years have been identified in observational studies from both prospective and retrospective data review, with various population groups and sample sizes, and are set forth below in Table 1.

TABLE 1
Modifiable Feeding and Parent Related Feeding Behaviors Associated
with Overweight or Obesity in Infants through Preschool Age

| Feeding, Nutrition, or Parent | Direction of Association to Overweight or |
|---|---|
| Feeding Behavior Variable | Obesity in Infants through Preschool Age |
| Breastfeeding | Breastfeeding duration and/or exclusivity is |
| | inversely associated with growth rates and BMI |
| | during infancy, and with measures of adiposity |
| | and/or risk of overweight and obesity in toddler and |
| | preschool age children. |
| Introductory age to complementary | Early age of introduction to complementary foods |
| foods | (e.g., <4 months) is positively associated with |
| | faster rate of weight gain during infancy, or |
| | increased weight for length or measures of |
| | adiposity in infants, toddlers, and preschool age |
| | children. |
| Diet Quality | |
| Energy dense diets | Total energy intake is positively associated with |
| | higher risk or prevalence of overweight in toddler |
| | and preschool age children. |
| Intake of sweetened beverages | Intake of calorically-sweetened beverages |
| | (excluding 100% juice) is positively related to |
| | measures of adiposity or overweight in toddler and |
| | preschool age children. |
| Fruit and vegetable consumption | Infants and preschool age children with high |
| | consumption of fruit and vegetables, of high |
| | availability of such, consume less total energy and |
| | are positively associated with more desirable body |
| | composition or body weight during preschool |
| | years. |
| Diet Quantity | |
| Portion size | Offering or providing large portion size is positively |
| | associated with increased energy intake in toddlers |
| | and preschool age children. No direct association |
| | confirms that large portions are independently |
| | associated with overweight or obesity in young chi [symbol] |
| Parent Feeding Behaviors: | |
| Attention to “hunger and satiety cues” | Lack of responsive parent feeding behavior, such |
| | as inattention to a child's hunger or satiety cues, is |
| | positively associated with overfeeding or |
| | overweight in infants and preschool age children. |
| Use of restrictive, controlling, | Parent feeding practices are positively associated |
| pressuring, or indulgent feeding | with weight fain during infancy, and overweight or |
| practices | obesity in preschool age children; depending on |
| | the parental feeding behavior, the direction of the |
| | association has not been consistently reported |
| | among |
| Shared Family Meals | Frequency of shared family meals per week is |
| | inversely associated with overweight, obesity, or |
| | increased risk in preschool age children. |
| Television/screen viewing time | Hours of television or screen time viewing is |
| | positively associated with overweight or obesity in |
| | preschool age children. |
| Duration of Sleep | Sleep duration is inversely associated with |
| | overweight, obesity, or measures of adiposity in |
| | infants, toddlers, and preschool age children. |

[symbol]

indicates data missing or illegible when filed

Studies of mother-infant dyads from birth, with measured height and weight during infancy or toddler years, reveal important associations with regard to recorded variables and the strength of their influence on a child's weight (see, Table 1). However, such reports are few. In addition, most observational study results assess cohorts of school-aged children, rather than infants.

A recent multi-review report assessed the evidence linking early factors and determinants of obesity, from conception to five years of age, and summarized findings of previously published systematic reviews. Monasta L., et al., “Early-life determinants of overweight and obesity: a review of systematic reviews,” Obes. Rev., 11:695-708 (2010). An analysis of factors associated with later overweight and obesity (from infancy through age 64 years) in the 22 reviews that met selection criteria included: none or limited breastfeeding, rapid infant growth, obesity in infancy, short infant sleep duration, infant TV viewing, maternal smoking, maternal diabetes, <30 minutes of daily physical activity, and consumption of sugar-sweetened beverages in early childhood. Associations supported by the 11 better-quality reviews included all but the latter three aforementioned factors.

Conclusions from observational studies of factors associated with pediatric obesity in children up to age five years are presented on Table 1 above. Those specifically rated in terms of adequate evidence by the American Academy of Pediatrics (“AAP”) or the American Dietetic Association (“ADA”) as being associated with pediatric obesity are reviewed below.

Breastfeeding

Breastfeeding is recognized as the ideal feeding for infants, due to its potential for health maintenance and disease prevention in infants. Among the multiple health benefits associated with breastfeeding, a protective effect from obesity has been recognized. Unfortunately, breastfeeding initiation rates among US women remain below that of many developed and developing countries, and according to the recent Surgeon General's Call to Action to support breastfeeding, the duration of providing breast milk to infants is sub-optimal. US Department of Health and Human Services. The Surgeon General's Call to Action to Support Breastfeeding, Washington, D.C.: US Department of Health and Human Services, Office of the Surgeon General, http://www.surgeongeneral.gov. (2011). Disparities in rates of initiating and maintaining breastfeeding are evident by race/ethnicity, socioeconomic characteristics, and geography in the US. For example, breastfeeding rates for black infants are about 50 percent lower than those for white infants at birth, age six months, and age twelve months, even when controlling for the family's income or educational level. In addition, mother's receiving benefits of the Supplemental Nutrition Program for Women, Infant, and Children (“WIC”) breastfeed at disproportionally lower rates than to those not receiving WIC, or those financially eligible for WIC but not enrolled in the program; women residing in southeastern US states have lower rates of breastfeeding than those in the northwestern states. US Department of Health and Human Services. The Surgeon General's Call to Action to Support Breastfeeding. Washington, D.C.: US Department of Health and Human Services, Office of the Surgeon General, http://www.surgeongeneral.gov. (2011).

As a whole, breastfeeding rates for the US population sampled by the Centers for Disease Control (“CDC”) reported that from 1999-2006 the majority (75%) of infants were provided some breast milk, but within three months, two-thirds (67%) had already received formula or other supplements. Centers for Disease Control and Prevention. Breastfeeding among U.S. children born 1999-2007, CDC National Immunization Survey. Available at: http://www_cdc_gov/breastfeeding/data/NIS_data/index htm Accessed Dec. 2, 2010 (2007). By six months of age, only 43% were still breastfeeding, and less than one quarter (23%) were breastfed at least twelve months. Unfortunately, nearly one-quarter (24.2%) to greater than half (52%) of breastfed infants receive formula while still in the hospital before two days of age, decreasing the likelihood of development of a full milk supply by the mother. Grummer-Strawn L. M., et al., “Infant feeding and feeding transitions during the first year of life,” Pediatrics, 122 Suppl 2:S36-S42 (2008); Siega-Riz A. M., et al., “Food consumption patterns of infants and toddlers: where are we now?,” J. Am. Diet. Assoc., 110:S38-S51 (2010).

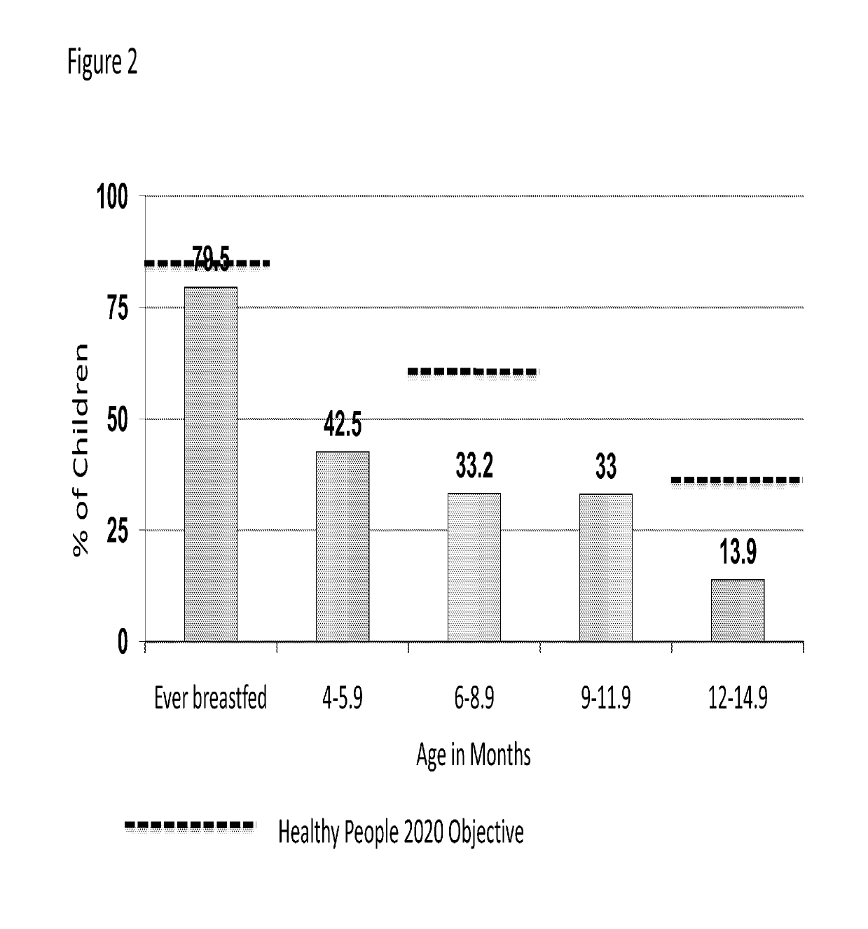

The Feeding Infants and Toddler Study (FITS) in 2008 surveyed a nationally representative sample of more than 3,000 infants, finding that nearly 80% of infants initiated (any) breastfeeding, yet by six months, only 37% were still breast fed, and far less (14%) were provided breast milk between 12-15 months of age, as shown in FIG. 2. Siega-Riz A. M., et al., “Food consumption patterns of infants and toddlers: where are we now?,” J. Am. Diet. Assoc., 110:S38-S51 (2010). Surveys demonstrate that although initiation rates of breastfeeding are acceptable toward the 2020 Healthy People Objective of 82%, there is a frank disparity between the duration goal of 61% breastfeeding prevalence at six months of age, and 34% at one year. U.S.Department of Health and Human Services. HealthyPeople.gov. Available at: http://www.healthy_people.gov/2020/default.aspx. Accessed Jan. 3, 2011 (2011).

Numerous studies, and at least five meta-analyses and systematic reviews have examined the role of breastfeeding in relation to childhood and adulthood obesity. Owen C. G., et al., “Effect of infant feeding on the risk of obesity across the life course: a quantitative review of published evidence,” Pediatrics, 115:1367-77 (2005); Owen C. G., et al., “The effect of breastfeeding on mean body mass index throughout life: a quantitative review of published and unpublished observational evidence,” Am. J. Clin. Nutr., 82:1298-307 (2005); Quigley M. A., “Duration of breastfeeding and risk of overweight: a meta-analysis,” Am. J. Epidemiol., 163:870-2 (2006); Harder T., et al., “Duration of breastfeeding and risk of overweight: a meta-analysis,” Am. J. Epidemiol., 162:397-403 (2005); Arenz S., et al., “Breast-feeding and childhood obesity—a systematic review,” Int. J. Obes. Relat. Metab. Disord., 28:1247-56 (2004). Not all conclusions are in agreement with regard to the strength of the obesity protective effect of breastfeeding; or, more correctly expressed, the increased risk of overweight with partial or exclusive infant formula feeding in the first four to six months of life. However, the vast majority of studies show some degree of an inverse association between breastfeeding and risk of obesity. Conclusions vary, primarily due to inconsistency with length of follow-up, definition of weight status, duration of breastfeeding, and confounding factors, which some analyses considered, and others did not. The statistical analyses procedures utilized to aggregate individual clinical trials may also explain differences in meta-analyses results. For example, a protective effect of breastfeeding on overweight (binary data analysis) has been reported by meta-analyses using logistic regression, whereas studies using linear regression and BMI (continuous data analysis) failed to detect meaningful significant associations. Beyerlein A., et al., “Breastfeeding and childhood obesity: shift of the entire BMI distribution or only the upper parts?,” Obesity (Silver Spring), 16:2730-3 (2008).

Three of the five meta-analyses of observational studies found that obesity risk at school age was reduced by 15-25% with early breastfeeding compared with formula feeding. Koletzko B., et al., “Can infant feeding choices modulate later obesity risk?,” Am. J. Clin. Nutr., 89:1502S-8S (2009). When at least three confounding factors (such as birth weight, parental weight, parental smoking, dietary factors, physical activity, or socioeconomic status) were considered, results indicated that the likelihood of obesity was 22% lower among breastfed children, compared to those not breastfed. Arenz S., et al., “Breast-feeding and childhood obesity—a systematic review,” Int. J. Obes. Relat. Metab. Disord., 28:1247-56 (2004). The stronger obesity-reducing benefits have been observed in some studies among adolescents, suggesting that breastfeeding effects may extend for years into a child's life. Another meta-analysis demonstrated a reduction in risk of obesity from 24%, before statistical adjustment for confounding variables, to a 7% reduced risk of later overweight after considering paternal weight status, smoking, and socioeconomic status. Owen C. G., et al., “Effect of infant feeding on the risk of obesity across the life course: a quantitative review of published evidence,” Pediatrics, 115:1367-77 (2005). A separate meta-analysis determined that the risk of becoming overweight was reduced by 4% for each month of breastfeeding, yet the effect realized a plateau after nine months of breastfeeding. Harder T., et al., “Duration of breastfeeding and risk of overweight: a meta-analysis,” Am. J. Epidemiol., 162:397-403 (2005). Taken together, results from the five meta-analyses identified above, published between 2004 and 2006, provide evidence that breastfeeding may have a relatively small, but consistent protective effect against obesity for children. Centers for Disease Control and Prevention. Breastfeeding among U.S. children born 1999-2007, CDC National Immunization Survey. Available at: http://www_cdc_gov/breastfeeding/data/NIS_data/index htm Accessed Dec. 2, 2010 (2007). The recently released Surgeon General's Call to Action unequivocally concluded that babies who are breastfed are less likely to become overweight and obese. US Department of Health and Human Services. The Surgeon General's Call to Action to Support Breastfeeding, Washington, D.C.: US Department of Health and Human Services, Office of the Surgeon General, http://www.surgeongeneral.gov. (2011).

The mechanisms by which breastfeeding could decrease risk of overweight or obesity remain unclear. For example, recent reports indicate that among preschoolers whose mothers had a high pregravid BMI, breastfeeding duration and parity played an important role in determining their risk of being overweight or obese, see, Kitsantas P., et al., “Risk profiles for overweight/obesity among preschoolers,” Early Hum. Dev., 86:563-8 (2010), and breastfeeding significantly decreased the likelihood of obesity in offspring of mothers with pregestational diabetes, independent of maternal BMI and diabetes type, see, Feig D. S., et al., “Breastfeeding predicts the risk of childhood obesity in a multi-ethnic cohort of women with diabetes,” J. Matern. Fetal Neonatal Med. (2010). Breast-fed infants may gain weight more slowly throughout infancy than formula-fed infants, possibly in part due to energy and protein intakes. Koletzko B., et al., “Can infant feeding choices modulate later obesity risk?,” Am. J. Clin. Nutr., 89:1502S-8S (2009); Koletzko B., et al., “Lower protein in infant formula is associated with lower weight up to age 2 y: a randomized clinical trial,” Am. J. Clin. Nutr., 89:1836-45 (2009). Increased intake of energy, protein, or both energy and protein in bottle fed infants, compared to breast fed infants, have been proposed as a factor. In addition, breastfeeding is associated with other advantages for decreasing the risk overweight development such as a lower frequency of introducing complementary foods at ages less than four months and less frequently offering high fat or high sucrose foods to infants at one year, compared to mothers that bottle feed their infants. Grummer-Strawn L. M., et al., “Infant feeding and feeding transitions during the first year of life,” Pediatrics, 122 Suppl 2:S36-S42 (2008); Hendricks K., et al., “Maternal and child characteristics associated with infant and toddler feeding practices,” J. Am. Diet. Assoc., 106:S135-S148 (2006).

While causality remains to be demonstrated, it is plausible that interactions among many obesity preventative and/or reductive feeding strategies coexist with breastfeeding. Moreover, the finely regulated supply-and-demand arrangement of breastfeeding between the mother infant dyad may be disrupted with bottle feeding. Consequently, reading and interpretation of hunger and satiety cues in turn may be significantly affected. Taveras E. M., et al., “To what extent is the protective effect of breastfeeding on future overweight explained by decreased maternal feeding restriction?,” Pediatrics, 118:2341-8 (2006).

Regardless of the strong suggestion that breastfeeding has at least some role in pediatric obesity, and that the exact sub-population of infants most likely to benefit from obesity prevention and/or reduction effects have yet to be determined, numerous other health benefits of offering breast milk to infants are indisputable. Any intervention in an infant population aimed at potentially reducing the risk of obesity and related health consequences would by necessity include effective encouragement, establishment, and continuation of breastfeeding for the first year of life.

Introduction Age to Complementary Foods

The AAP recommends that age-appropriate solid foods be introduced as indicated by the individual child's nutritional and developmental needs, but no sooner than four months and preferably six months of age. American Academy of Pediatrics, American Public Health Association and National Resource Center for Health and Safety in Child Care and Early Education. Preventing Childhood Obesity in Early Care and Education: Selected Standards from Caring for Our Children: National Health and Safety Performance Standards; Guidelines for Early Care and Education Programs, 3rd Edition. http://nrckids.org/CFOC3/PDFVersion/preventing_obesity.pdf (2010). Provision of solid food that is not synchronized to developmental milestones and physiologic and immune readiness may be linked to allergies and digestive problems, and early introduction of solids is associated with increased risk for childhood obesity. Taveras E. M., et al., “Racial/ethnic differences in early-life risk factors for childhood obesity,” Pediatrics 2010; 125:686-95 (2010); Ong K. K., “Dietary energy intake at the age of 4 months predicts postnatal weight gain and childhood body mass index,” Pediatrics, 117:e503-e508 (2006); Kleinman, R. E., “Pediatric nutrition handbook. 6th ed.,” Elk Grove Village, Ill.: American Academy of Pediatrics (2009); Grummer-Strawn L. M., et al., “Infant feeding and feeding transitions during the first year of life,” Pediatrics, 122 Suppl 2:S36-S42 (2008).

Early introduction of solid foods may simply provide an infant excess calories, particularly if the infant's regulation of milk intake is not self adjusted. A recent study of 847 infants identified a potential interaction among timing of introduction of complementary foods, breastfeeding status, and weight during the toddler years. Among infants breastfed for at least four months, the timing of solid food introduction was not associated with obesity at three years of age. However, among formula-fed infants, introduction of solid foods before four months (compared to those provided complementary foods at four to five months) was associated with a significant six fold increase in odds of obesity at age three years, even after the adjustment of covariates. Huh S. Y., et al., “Timing of Solid Food Introduction and Risk of Obesity in Preschool-Aged Children,” Pediatrics (2011). Formula-fed infants may increase their energy intake from early foods, compared to those not consuming solid foods, without decreasing calories from bottle feedings, whereas breastfeeding may promote more self regulation of an infant's energy intake. Taveras E. M., et al., “To what extent is the protective effect of breastfeeding on future overweight explained by decreased maternal feeding restriction?,” Pediatrics, 118:2341-8 (2006); Wasser H., et al., “Infants perceived as “fussy” are more likely to receive complementary foods before 4 months,” Pediatrics, 127:229-37 (2011).

National estimates for the prevalence of parents providing complementary foods prior to the AAP guidelines for developmental readiness vary. The FITS survey in 2002, documented that 26% of infants were introduced to solid foods before four months of age. Hendricks K., et al., “Maternal and child characteristics associated with infant and toddler feeding practices,” J. Am. Diet. Assoc., 106:S135-S148 (2006). The latest FITS survey in 2008 indicated that approximately 10% of parents introduced infants to complementary foods prior to four months of age, indicating an improvement in this practice in the last 6-8 years. Siega-Riz A. M., et al., “Food consumption patterns of infants and toddlers: where are we now?,” J. Am. Diet. Assoc., 110:S38-S51 (2010). However, national estimates for the prevalence of only African-American infants consuming solid foods before four months was reported as 62.5% in 2008, and regional differences in parent feeding solid food practices exist, as evident by a smaller sample (n=217) of first-time black mothers participating in the WIC program in one US state in which 77% of three month olds were provided solid foods. Grummer-Strawn L. M., et al., “Infant feeding and feeding transitions during the first year of life,” Pediatrics, 122 Suppl 2:S36-S42 (2008); Wasser H., et al., “Infants perceived as “fussy” are more likely to receive complementary foods before 4 months,” Pediatrics, 127:229-37 (2011).

An infant's developmental readiness determines which foods should be fed, what texture the foods should be, and which feeding styles to use. Although age and size often correspond with developmental readiness, these should not be used as sole considerations for deciding what and how to feed babies. U.S.Department of Agriculture, Food and Nutrition Service. Feeding infants: A guide for use in the child nutrition programs. Rev ed. Alexandria, Va.: USDA, FNS. http://www.fns.usda.gov/tn/resources/feeding_infants.pdf (2002). Teaching parents to identify the appropriate developmental readiness milestones through an anticipatory guidance approach may be useful in delaying the inappropriate introduction of complementary foods at an early age which has been associated with early or excessive weight gain.

Diet Quality and Quantity

The most comprehensive assessment of the diet of infants and toddlers in the US are the Feeding Infants and Toddlers Studies (“FITS”). These dietary intake surveys with large, representative, cross-sectional samples of parents and caregivers, in infants from birth to 48 months of age, provide detailed information on the eating patterns and nutrient intakes of infants, toddlers, and preschoolers, and confirm that obesity associated dietary factors are highly prevalent in the US infant population.

The FITS 2002 dietary survey of over 3,000 infants and toddlers aged 4-24 months was recently followed by the FITS 2008 survey of 3273 infants and children age 0-4 years of age. The first FITS data, published in 2004, documented that even at four months of age, average daily caloric intakes exceeded standard recommendations by 10%, and the excess intake steadily rose with age until children age 12-24 months old were consuming over 30% more calories than their estimated energy requirements. Kuczmarski et al., CDC growth charts: United States. Advance data from vital and health statistics; No. 314. National Center for Health Statistics, http://www.cdc.gov/nchs/data/ad/ad314.pdf (2000); Devaney B., et al., “Nutrient intakes of infants and toddlers,” J. Am. Diet. Assoc., 104:s14-s21 (2004). Portion sizes consumed by infants and toddlers exceeded recommendations for 50-90% of the children. Fox M. K., et al., “Relationship between portion size and energy intake among infants and toddlers: evidence of self-regulation,” J. Am. Diet. Assoc., 106:S77-S83 (2006).

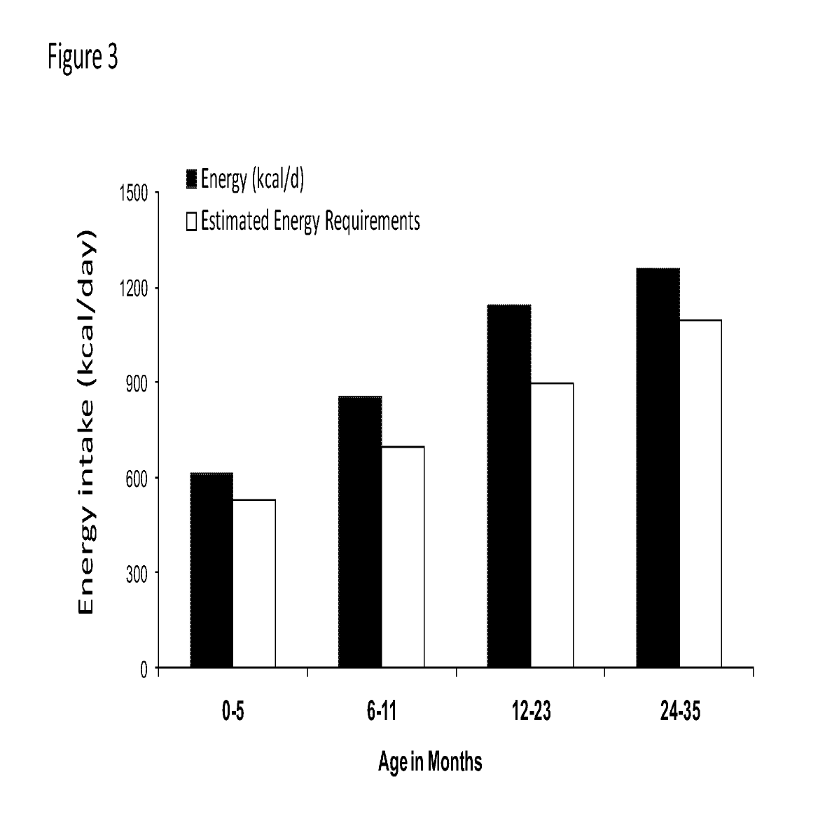

As assessed by both the ADA and AAP, high intake of energy dense foods and diets, and/or large portions are associated with risk of obesity in children. American Dietetic Association. Evidence Analysis Library Evidence-based Pediatric Weight Management Nutrition Practice Guideline. http://www.adaevidencelibrary.com, Accessed December, 2010 (2011); Barlow S. E., “Expert committee recommendations regarding the prevention, assessment, and treatment of child and adolescent overweight and obesity: summary report,” Pediatrics, 120 Suppl 4:S164-S192 (2007). Currently, infants and young children are consuming calories in excess of their estimated energy requirement, as shown in FIG. 3. In 2008, the youngest infants consumed nearly 14% more calories (83 kcal/d) than estimated needs. Assuming the energy estimated from the FITS study and applying the first law of thermodynamics, in its simplest form, after six weeks of 83 additional kcal/day, an estimated one pound excess weight gain would be possible, and after only six months, and an additional 4.3 pounds of weight could be predicted. Utilizing an average weight of 18 pounds for a six-month old infant boy, the weight differential of 4.3 pounds corresponds to the difference between a weight for age between the 50^{th} percentile and the 95^{th} percentile.

As caloric intake from FITS participants exceeded estimated needs throughout infancy and toddler years, it could be argued that parents consistently overestimated food intake, or that estimated energy requirements are possibly too low. Regardless, caloric content of infant and young children's diets is likely contributing, to some degree, to the prevalence of overweight and obesity in today's youth.

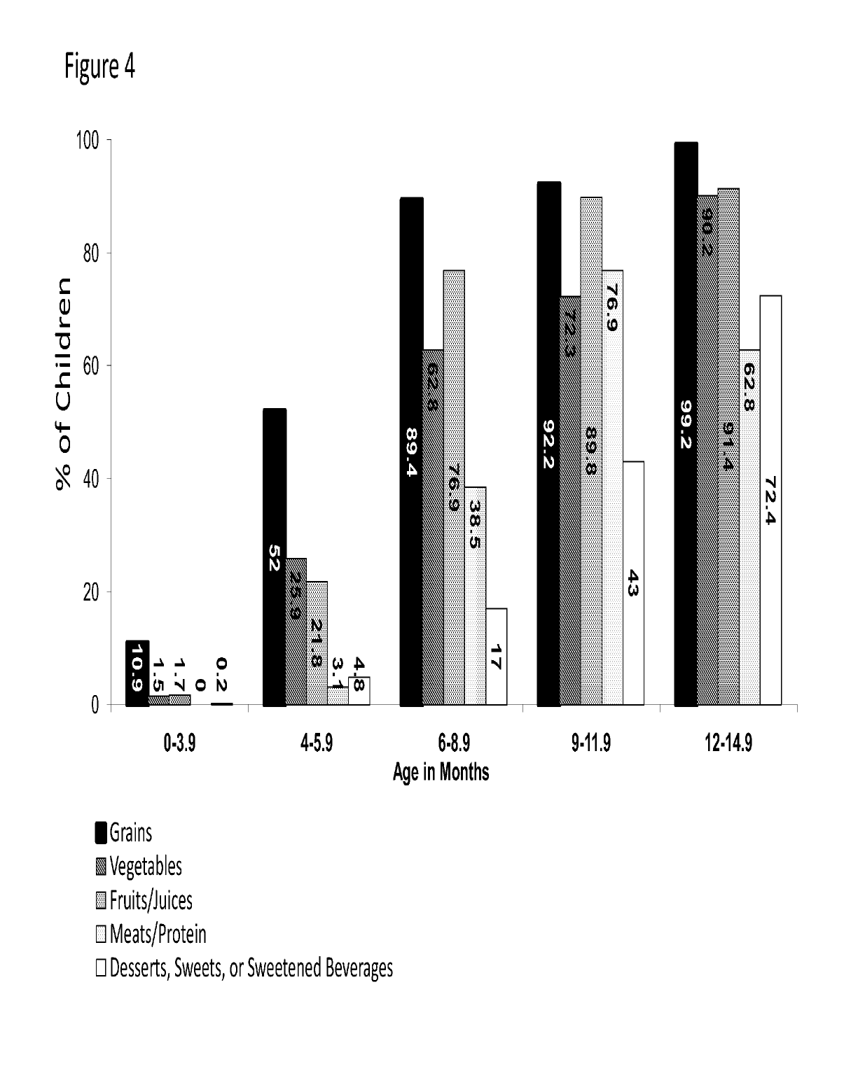

Many infants in the 2008 FITS survey consumed infant cereal along with other early food choices of vegetables, fruits, and meats, as shown in FIG. 4 However, energy dense dessert foods such cookies, cakes, candy or a sweetened beverage were consumed by nearly 20% of the six to nine month old infants and by nearly 45% of nine to eleven month old infants. At one year of age, approximately 55% of infants were consuming desserts, sweets, or sweetened beverages and by fifteen months of age, two-thirds of toddlers consumed this category of foods daily, a level of intake that tended to remain constant throughout the toddler years. Siega-Riz A. M., et al., “Food consumption patterns of infants and toddlers: where are we now?,” J. Am. Diet. Assoc., 110:S38-S51 (2010); Fox M. K., et al., “Food consumption patterns of young preschoolers: are they starting off on the right path?,” J. Am. Diet. Assoc., 110:S52-S59 (2010). Consumption of sugar sweetened beverages and energy dense foods have been identified by the ADA and AAP as a dietary risk factor for childhood obesity and meta analyses have established the degree to which sweetened beverage intake in children contributes to obesity. American Dietetic Association. Evidence Analysis Library Evidence-based Pediatric Weight Management Nutrition Practice Guideline. http://www.adaevidencelibrary.com, Accessed December (2010); Barlow S. E., “Expert committee recommendations regarding the prevention, assessment, and treatment of child and adolescent overweight and obesity: summary report,” Pediatrics, 120 Suppl 4:S164-S192 (2007). Effect sizes range from −0.03, see, Forshee, R. A., et al., “Sugar-sweetened beverages and body mass index in children and adolescents: a meta-analysis,” Am. J. Clin. Nutr., 87:1662-71 (2008), to −0.08 unit change in BMI per twelve fl oz of soda per day, see, Malik, V. S., et al., “Sugar-sweetened beverage and BMI in children and adolescents: reanalyses of a meta-analysis,” Am. J. of Clin. Nutr., 438-439 (2009), depending upon the length of follow-up, of which varied among studies. In addition a recent systematic literature review of sweetened beverage intake and body weight identified three nationally representative studies and twelve other observational studies that found statistically significant positive associations between sweetened beverage and adiposity. Woodward-Lopez, G., “To what extent have sweetened beverages contributed to the obesity epidemic?”, Public Health Nutrition, (2010). Although other trials analyzed did not have significantly positive results, 83% of the highest-quality rated studies with cross-sectional analysis of children identified a positive relationship. Interventions that are successful in reducing sweetened beverage consumption among children are likely to have a measurable impact on weight status. Wang and colleagues estimated that if water replaced sweetened beverages consumed by children aged two years and older, total energy intake would be decreased by an average of 235 kcal/day. Wang, Y. C., “Impact of Change in Sweetened Caloric Beverage Consumption on Energy Intake Among Children and Adolescents,” Arch. Pediatr. Adolesc. Med., vol. 163, no. 4 (2009).

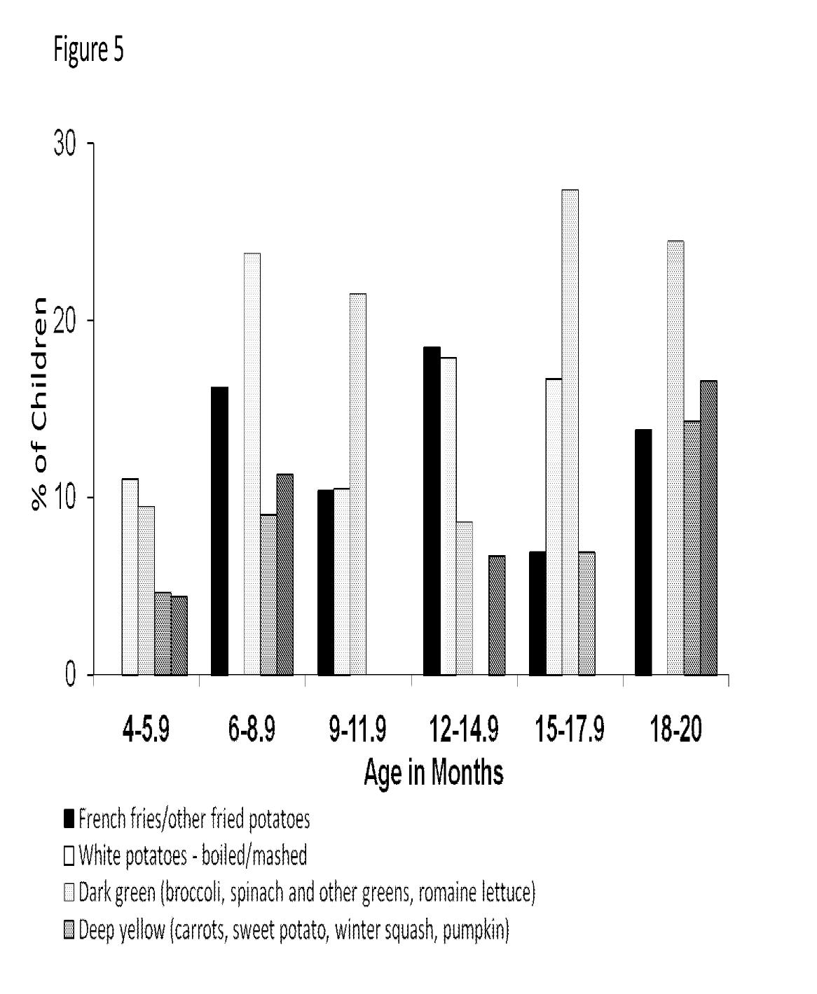

In contrast to the strong development of the innate preference for sweets, FITS data suggest that the more difficult to develop acceptance of sour or bitter tastes, such as with vegetables, may have been lacking or not sustained in infants. According to the 2008 FITS data, 35% of infants age six to nine months and 25% of nine to twelve month olds did not consume a single serving of vegetables on a given day, as shown in FIG. 4. Siega-Riz A. M., et al., “Food consumption patterns of infants and toddlers: where are we now?,” J. Am. Diet. Assoc., 110:S38-S51 (2010). Overall, a consumption pattern for the percent of infants and toddlers including any vegetable in the daily diet appeared to stay relatively constant from six to nine months of age through the preschool years (suggesting that if infants developed an early acceptance for vegetables, consumption may follow through the toddler years). However, yellow or orange colored vegetables were consumed by approximately 35% of six to nine month old infants, but fell to less than 25% by twelve months; by eighteen months, approximately 20% of toddlers continued to consuming them on any given day. Few six to nine month olds consumed green or mixed garden vegetables on the study survey day, and approximately 10% were eating green vegetables from twelve months of age through the early toddler years. Instead, white potato, particularly fried potatoes, was the most frequently consumed “vegetable” of children aged twelve to fifteen months of age (18.5%) and remained a daily dietary habit of many toddlers, as shown in FIG. 5. Siega-Riz A. M., et al., “Food consumption patterns of infants and toddlers: where are we now?,” J. Am. Diet. Assoc., 110:S38-S51 (2010); Fox M. K., et al., “Food consumption patterns of young preschoolers: are they starting off on the right path?,” J. Am. Diet. Assoc., 110:S52-S59 (2010). Of children aged one to two years, 33% were eating meals or snacks at a fast-food restaurant, on a daily basis, which may explain the frequency of fried potato intake.

The AAP identifies that infants less than six months of age should not be served juice. Holt, K., et al., “Bright Future Nutrition,” American Academy of Pediatrics (2011). Whole fruit, mashed or pureed, is appropriate for infants once complementary feeding begins, up to one year of age. Children one year of age through age six should be limited to a total of four to six ounces of juice per day. American Academy of Pediatrics, American Public Health Association and National Resource Center for Health and Safety in Child Care and Early Education. Preventing Childhood Obesity in Early Care and Education: Selected Standards from Caring for Our Children: National Health and Safety Performance Standards; Guidelines for Early Care and Education Programs, 3rd Edition. http://nrckids.org/CFOC3/PDFVersion/preventing_obesity.pdf (2010). Early introduction and acceptance of fruit or 100% fruit juice during infancy appears to track into toddlerhood and generally follows through the pre-school years. Fox M. K., et al., “Food consumption patterns of young preschoolers: are they starting off on the right path?,” J. Am. Diet. Assoc., 110:S52-S59 (2010).

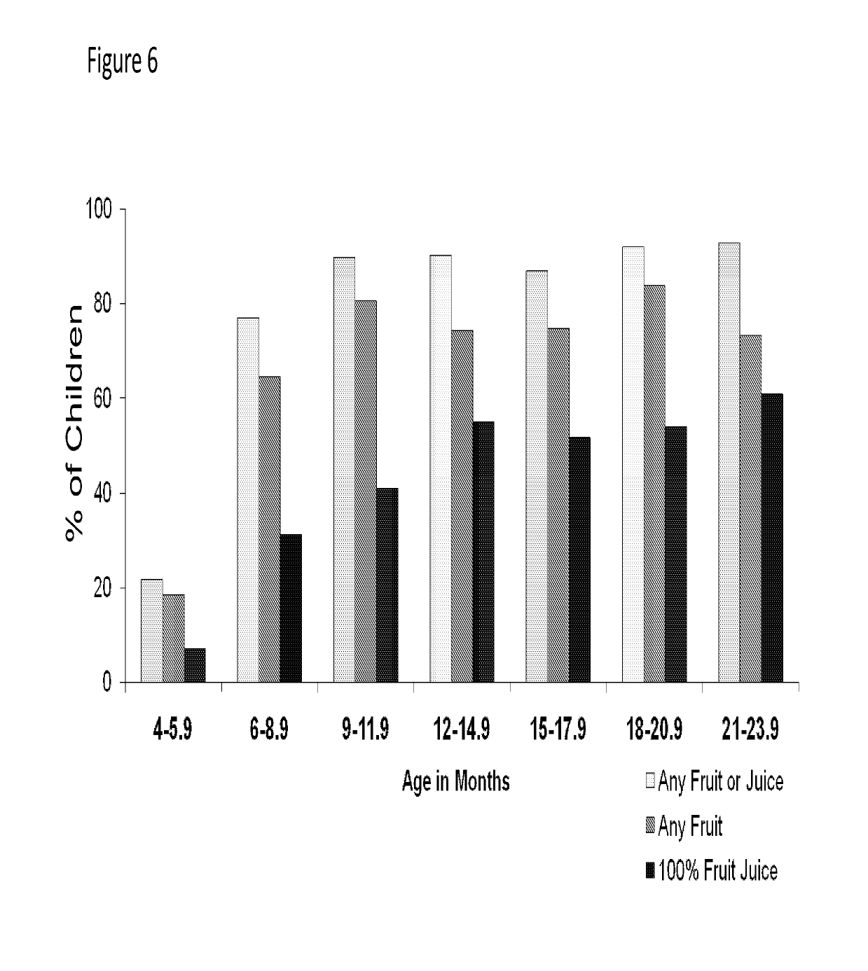

An encouraging finding from the 2008 FITS data, compared to the earlier survey, is related to fruit and whole fruit juice consumption by infants and toddlers. Compared to results from the 2002 survey, in 2008 the frequency of juice consumption before six months of age dropped from 18.7% to 7.1%, respectively. Approximately 65% of infants age six to nine months consumed fruit on any given day, as well as 80% of those age nine to twelve months old. Including the combination of fruit or 100% fruit juice intake, at nine months of age, the percentage of infants and toddlers consuming such tended to remain or exceed an 80% consumption level throughout two years of age, as shown in FIG. 6.

Parental preference for, and modeling of healthful eating behaviors, with multiple, unemotional offerings of new foods can help shape children's preferences. Skinner J. D., et al., “Children's food preferences: a longitudinal analysis,” J. Am. Diet. Assoc., 102:1638-47 (2002); Hendy H. M., et al., “The Parent Mealtime Action Scale (PMAS). Development and association with children's diet and weight,” Appetite, 52:328-39 (2009); Klohe-Lehman, D. M., et al., “Low-Income, Overweight and Obese Mothers as Agents of Change to Improve Food Choices, Fat Habits, and Physical Activity in their 1-to-3-Year-Old Children,” J. Am. College of Nutrition, vol. 26, no. 3, 196-208 (2007); Wardle J., et al., “Increasing children's acceptance of vegetables; a randomized trial of parent-led exposure,” Appetite, 40:155-62 (2003); Wardle J., et al., “Modifying children's food preferences: the effects of exposure and reward on acceptance of an unfamiliar vegetable,” Eur. J. Clin. Nutr., 57:341-8 (2003); Birch L. L., et al., “Infants' consumption of a new food enhances acceptance of similar foods,” Appetite, 30:283-95 (1998); Williams K. E., et al., “Practice does make perfect. A longitudinal look at repeated taste exposure,” Appetite, 51:739-42 (2008). Increased availability of nutritious foods, in a form and location that is conducive with consumption, leads to improved diet quality in young children, for children's food preferences, and their diets, often reflect foods that are available to them, in part, because familiarity drives preference. O'Connor T. M., et al., “Parenting practices are associated with fruit and vegetable consumption in pre-school children,” Public Health Nutr, 13:91-101 (2010).

The FITS studies document that in the US infant population, caloric intake above estimated requirements, high consumption of energy dense and sweetened foods, low vegetable consumption, and overall high energy consumption (all of which are obesity associated), are highly prevalent. High energy intake, and inadequate meal and snack patterns of infants appear to become well established prior to their first birthday, see, Skinner J. D., et al., “Meal and snack patterns of infants and toddlers,” J. Am. Diet. Assoc., 104:s65-s70 (2004), and food preferences are set at an early age, probably by age two, a time at which excess body weight is predictive of future childhood obesity, see, Harrington J. W., et al., “Identifying the “Tipping Point” Age for Overweight Pediatric Patients,” Clin. Pediatr. (Phila) (2010). Moreover, by age two, many children have assumed the eating habits of the family. Dwyer J. T., et al., “FITS: New insights and lessons learned,” J. Am. Diet. Assoc., 104:s5-s7 (2004).

The studies mentioned above, all point to specific examples of modifiable behaviors, regarding complementary food introduction which may have greater effectiveness and efficacy impact in infancy than attempting modifications in diet patterns once these are established. For example, simple messages that educate parents and caregivers about healthy feeding and dietary habits for infants and toddlers include those that encourage a wide variety of nutritious foods, especially fruits and vegetables, in forms that are developmentally appropriate for the child, and with frequency and persistence of offerings to generate acceptance. Briefel R. R., et al., “Feeding infants and toddlers study: Improvements needed in meeting infant feeding recommendations,” J. Am. Diet. Assoc., 104:s31-s37 (2004); Dwyer J. T., et al., “Feeding Infants and Toddlers Study 2008: progress, continuing concerns, and implications,” J. Am. Diet. Assoc., 110:S60-S67 (2010). Offering appropriate portion sizes and teaching parents to allow children to recognize and honor their hunger and satiety cues, rather than “clean your plate” or coercive feeding practices are also consistent with conclusions from FITS results, and the promotion of healthy weight. Briefel R. R., et al., “Feeding infants and toddlers study: Improvements needed in meeting infant feeding recommendations,” J. Am. Diet. Assoc., 104:s31-s37 (2004); Fox M. K., et al., “Relationship between portion size and energy intake among infants and toddlers: evidence of self-regulation,” J. Am. Diet. Assoc., 106:S77-S83 (2006). Planning toddler's snacks, of which contribute about 25% of a toddler's daily energy intakes, to complement meals by including fruits, vegetables and whole grains, rather than fruit flavored drinks and desert type foods, as well as limiting exposure to fast food restaurants in infancy, all provide additional practical examples of modifiable healthy food practices that parents can engage. Fox M. K., et al., “Food consumption patterns of young preschoolers: are they starting off on the right path?,” J. Am. Diet. Assoc., 110:S52-S59 (2010); Skinner J. D., et al., “Meal and snack patterns of infants and toddlers,” J. Am. Diet. Assoc., 104:s65-s70 (2004).

Caregiver Feeding Behaviors

If provided the opportunity, infants and young toddlers will exert an innate ability to regulate energy intake. Fox M. K., et al., “Relationship between portion size and energy intake among infants and toddlers: evidence of self-regulation,” J. Am. Diet. Assoc., 106:S77-S83 (2006); Fomon S. J., et al., “Influence of formula concentration on caloric intake and growth of normal infants,” Acta. Paediatr. Scand., 64:172-81 (1975); Birch L. L., et al., “Caloric compensation and sensory specific satiety: evidence for self regulation of food intake by young children,” Appetite, 7:323-31 (1986); Rolls B. J., et al., “Serving portion size influences 5-year-old but not 3-year-old children's food intakes,” J. Am. Diet. Assoc., 100:232-4 (2000). However, innate self-regulation of caloric intake can be easily overridden by well meaning, yet misguided parent feeding behaviors. As mentioned above, inadequate feeding behaviors associated to bottle feeding of infant formula, where hunger and satiety cues may require more attention to be recognized compared to breastfeeding, or the use of bottle feeding as a method for soothing infants, may all contribute to greater than expected energy and protein intake in early life.

The influence of parental behaviors associated to feeding continues to be relevant with the introduction of weaning food, and throughout childhood. Although a complex relationship has been proposed between how parents feed their infants and children and a young child's weight status, correlation evidence is increasingly being documented linking parent feeding styles, behaviors, and attitudes to infant or childhood weight status, even when considering several confounding variables. Rhee K. E., et al., “Parenting styles and overweight status in first grade,” Pediatrics, 117:2047-54 (2006); Hughes S. O., et al., “Indulgent feeding style and children's weight status in preschool,” J. Dev. Behav. Pediatr., 29:403-10 (2008); Farrow C., et al., “Does maternal control during feeding moderate early infant weight gain?,” Pediatrics, 118:e293-e298 (2006); Wake M., et al., “Preschooler obesity and parenting styles of mothers and fathers: Australian national population study,” Pediatrics, 120:e1520-e1527 (2007); Chen J. L., et al., “Factors associated with obesity in Chinese-American children,” Pediatr. Nurs., 31:110-5 (2005); Hendy H. M., et al., “The Parent Mealtime Action Scale (PMAS). Development and association with children's diet and weight,” Appetite, 52:328-39 (2009). Specifically, parental use of food as a solace or reward for their children, see, Kroller K., et al., “Maternal feeding strategies and child's food intake: considering weight and demographic influences using structural equation modeling,” Int. J. Behav. Nutr. Phys. Act., 6:78 (2009), restricting their access to food, see, Fisher J. O., et al., “Restricting access to palatable foods affects children's behavioral response, food selection, and intake,” Am. J. Clin. Nutr., 69:1264-72 (1999), particularly if fueled by parental concern about overeating, see, Burdette H. L., et al., “Maternal infant-feeding style and children's adiposity at 5 years of age,” Arch. Pediatr. Adolesc. Med., 160:513-20 (2006) or child's weight, see, Santos J. L., et al., “Maternal anthropometry and feeding behavior toward preschool children: association with childhood body mass index in an observational study of Chilean families,” Int. J. Behav. Nutr. Phys. Act., 6:93 (2009), have been rather consistently implicated. The AAP underscores that offering food as a reward or punishment places undue importance on food and may have negative effects leading to obesity or poor eating behavior. American Academy of Pediatrics, American Public Health Association and National Resource Center for Health and Safety in Child Care and Early Education. Preventing Childhood Obesity in Early Care and Education: Selected Standards from Caring for Our Children: National Health and Safety Performance Standards; Guidelines for Early Care and Education Programs, 3rd Edition. http://nrckids.org/CFOC3/PDFVersion/preventing_obesity.pdf. (2010).

Excessive “maternal control during feeding” at the weaning period, see, Farrow C., et al., “Does maternal control during feeding moderate early infant weight gain?,” Pediatrics, 118:e293-e298 (2006), or school age years, see, Spruijt-Metz D., et al., “Relation between mothers' child-feeding practices and children's adiposity,” Am. J. Clin. Nutr., 75:581-6 (2002), and “inattention to infant and toddler hunger and satiety cues,” see, Worobey J., et al., “Maternal behavior and infant weight gain in the first year,” J. Nutr. Educ. Behav., 41:169-75 (2009), have been reported as factors related to diet quality, quantity, food choice, or weight status among infants and young children. For example, parent “inattention to hunger and satiety cues” has been associated with weight gain at four to five months, see, Gross R. S., et al., “Maternal perceptions of infant hunger, satiety, and pressuring feeding styles in an urban Latina WIC population,” Acad. Pediatr., 10:29-35 (2010), and predictive of weight gain at six to twelve months by parents lacking such skill, see, Worobey J., “Maternal behavior and infant weight gain in the first year,” J. Nutr. Educ. Behav., 41:169-75 (2009). One recent study of 368 mothers in an urban US city revealed that 70% believed that if their infant was crying, he must be hungry. Kavanagh K. F., et al., “Educational intervention to modify bottle-feeding behaviors among formula-feeding mothers in the WIC program: impact on infant formula intake and weight gain,” J. Nutr. Educ. Behav., 40:244-50 (2008). Parental education about reading appropriate hunger cues, and acceptance of alternative soothing options, rather than immediate feeding, may be helpful to prevent overfeeding.

It is unlikely that parent feeding styles of low attention to infant cues for hunger and satiety are transient, or that children do not adapt to such by learning to overeat. At two years of age, children participating in laboratory tasks designed to assess their self-regulation skills that ranked lower on inhibitory control and higher on reward sensitivity skills were more likely to be overweight at five years of age than their counterparts. Graziano P. A., et al.,” Toddler self-regulation skills predict risk for pediatric obesity,” Int. J. Obes. (Lond), 34:633-41 (2010). In addition, both children with younger ages (three to five years) and older ages (eight to eleven years) in higher weight categories had lower satiety response and higher response to food cues, even after controlling for parental education and BMI. Carnell S., et al., “Appetite and adiposity in children: evidence for a behavioral susceptibility theory of obesity,” Am. J. Clin. Nutr., 88:22-9 (2008).

It appears that “responsive feeding,” where the parents or caregivers recognize and respond to infant and child cues, can help foster trust and appears to reduce potential overfeeding. American Academy of Pediatrics, American Public Health Association and National Resource Center for Health and Safety in Child Care and Early Education. Preventing Childhood Obesity in Early Care and Education: Selected Standards from Caring for Our Children: National Health and Safety Performance Standards; Guidelines for Early Care and Education Programs, 3rd Edition. http://nrckids.org/CFOC3/PDFVersion/preventing_obesity.pdf (2010). Feeding infants on cue, rather than on a schedule, may help prevent and/or reduce childhood obesity. Taveras E. M., et al., “To what extent is the protective effect of breastfeeding on future overweight explained by decreased maternal feeding restriction?,” Pediatrics, 118:2341-8 (2006); Satter, E., “Child of mine: Feeding with love and good sense,” 3rd ed. Boulder, Colo.: Bull Publishing (2000). When infants and children are “cue fed,” they are in control of frequency and amount of feedings. American Academy of Pediatrics, American Public Health Association and National Resource Center for Health and Safety in Child Care and Early Education. Preventing Childhood Obesity in Early Care and Education: Selected Standards from Caring for Our Children: National Health and Safety Performance Standards; Guidelines for Early Care and Education Programs, 3rd Edition. http://nrckids.org/CFOC3/PDFVersion/preventing_obesity.pdf (2010); Satter E. M., “Internal regulation and the evolution of normal growth as the basis for prevention of obesity in children,” J. Am. Diet. Assoc., 96:860-4 (1996). As a consequence, very early attention and appropriate responsiveness by parents to hunger and satiety cues may have long reaching effects on feeding behaviors of children.

The division of responsibility feeding model proposed by Satter has been suggested as a means to encourage a parent-child feeding relationship in which internal regulation by the child is fostered as an attempt to allow for normal growth and prevention and/or reduction of obesity in children. Satter E. M., “Internal relationships to child eating and weight status,” Obes. Res., 12:1711-22 (2004); Francis L. A., et al., “Maternal weight status modulates the effects of restriction on daughters' eating and weight,” Int. J. Obes. (Lond), 29:942-9 (2005); Faith M. S., et al., “Infant and child feeding practices and childhood overweight: the role of restriction,” Matern. Child. Nutr., 1:164-8 (2005); Clark H. R., et al., “How do parents' child-feeding behaviours influence child weight? Implications for childhood obesity policy,” J. Public Health (Oxf), 29:132-41 (2007). In some infants and toddlers, a favorable influence of restriction on the intake of energy-dense foods and snacks has been reported. Gross R. S., et al., “Maternal perceptions of infant hunger, satiety, and pressuring feeding styles in an urban Latina WIC population,” Acad. Pediatr., 10:29-35 (2010). The AAP identifies that children are responsible for participating in choices about food selection (within the healthy food options provided by the parent) and should be allowed to take responsibility for determining how much is consumed at each eating occasion. Kleinman, R., “Pediatric nutrition handbook,” 6th ed. Elk Grove Village, Ill.: American Academy of Pediatrics (2009). Using this approach, along with providing small portions of new foods and praising the child for eating healthy foods has been positively associated with consumption of nutritious foods by preschool age children. Nicklas, T. A., et al., “Eating Patterns, Dietary Quality and Obesity,” J. Am. College of Nutrition, vol. 20, no. 6, 599-608 (2001). When parental control is applied in a general atmosphere of involvement and parental warmth (e.g., authoritative parenting), it has lead to positive food choices by young children. Patrick H., et al., “A review of family and social determinants of children's eating patterns and diet quality,” J. Am. Coll. Nutr., 24:83-92 (2005).

Although associations between parental feeding behaviors and subsequent early childhood risk of overweight are well documented, due the nature of the observational research, a causal relation cannot be concluded. It is difficult to discern if certain child factors evoke parenting feeding practices, or whether parent feeding behaviors influence these child factors. Moreover, as reviewed by Ventura and Birch, and Anzman and Birch, the majority of research in the arena of parent feeding behaviors and childhood weight is cross-sectional, or performed in a feeding-laboratory setting. Ventura A. K., et al., “Does parenting affect children's eating and weight status?,” Int. J. Behav. Nutr. Phys. Act., 5:15 (2008); Anzman S. L., et al.,

Given the above findings, education on feeding behavior that is directed by the parent, with high responsiveness to hunger and satiety cues, allowing for self-regulation of food intake by the child, is needed to curb the potential adverse effects that parent feeding styles can have on children's innate ability to regulate energy intake. Fox M. K., et al., “Relationship between portion size and energy intake among infants and toddlers: evidence of self-regulation,” J. Am. Diet. Assoc., 106:S77-S83 (2006). Such an intervention would also require practical education of parents as to the different hunger and satiety cues associated to each developmental stage of the infant, especially from birth to two years of age, and ideally be delivered in an anticipatory way, prior to the infant reaching the next stage of development, rather than recommending remedial approaches once an infant is past this formative stage. Interventions for obesity prevention and/or reduction that do not address constructs regarding parenting approaches to feeding are unlikely to be successful. Hubbs-Tait L., et al., “Parental feeding practices predict authoritative, authoritarian, and permissive parenting styles,” J. Am. Diet. Assoc., 108:1154-61 (2008). However, to date, no large study representative of the general infant population has addressed these constructs within a multifactorial approach towards the prevention and/or reduction of childhood obesity.

TV/Screen Viewing Time and Active Play

The American Academy of Pediatrics consensus Statement on Prevention and Treatment of Childhood Obesity recommends that children two years old and younger should not be exposed to television, and children over age two should limit daily media exposure to only one to two hours of quality programming for TV viewing and computer use. Barlow S. E., “Expert committee recommendations regarding the prevention, assessment, and treatment of child and adolescent overweight and obesity: summary report,” Pediatrics, 120 Suppl 4:S164-S192 (2007). In contrast to these recommendations, survey data show that by three months of age, approximately 40% of infants regularly watch videos, DVD's, or television and 90% of children under age two watch television daily. Zimmerman F. J., et al., “Television and DVD/video viewing in children younger than 2 years,” Arch. Pediatr. Adolesc. Med., 161:473-9 (2007).

There is solid evidence that increased TV viewing and screen time has been associated with obesity and adiposity in pre-school children within multiple cohorts and studies. Mendoza J. A., et al., “Television viewing, computer use, obesity, and adiposity in US preschool children,” Int. J. Behav. Nutr. Phys. Act., 4:44 (2007); LaRowe, T. L., et al., “Dietary Intakes and Physical Activity among Preschool Aged Children living in Rural American Indian Communities Prior to a Family-based Healthy Lifestyle Intervention,” J. Am. Diet. Assoc., 110(7):1049-1057 (2010); Certain, L. K., et al., “Prevalence, Correlates, and Trajectory of Television Viewing Among Infants and Toddlers,” Pediatrics, 109, 643 (2002); Dennison, B. A., et al., “Television Viewing and Television in Bedroom Associated With Overweight Risk Among Low-Income Preschool Children,” Pediatrics, 109, 1028 (2002). In contrast, the AAP indicates that physical activity can prevent a rapid gain in weight which leads to childhood obesity early in life. American Academy of Pediatrics, American Public Health Association and National Resource Center for Health and Safety in Child Care and Early Education. Preventing Childhood Obesity in Early Care and Education: Selected Standards from Caring for Our Children: National Health and Safety Performance Standards; Guidelines for Early Care and Education Programs, 3rd Edition. http://nrckids.org/CFOC3/PDFVersion/preventing_obesity.pdf (2010). Although some experts recommend that infants should have supervised “tummy time” every day when they are awake and that confining infant equipment such as swings, infant seats (e.g., bouncers), if used, should only be allowed for short periods of time, data to evaluate the prevalence of these behaviors at home, or in infant care settings, and their association to overweight, obesity, or rapid weight gain in infancy are not available. American Academy of Pediatrics, “Back to sleep, tummy to play” (2008).

Parents may need education and encouragement to provide a least restrictive environment to foster active play time for their young infants and opportunities for gross motor activity. Ammerman A. S., et al., “An intervention to promote healthy weight: Nutrition and Physical Activity Self-Assessment for Child Care (NAP SACC) theory and design,” Prev. Chronic. Dis., 4:A67 (2007); Benjamin S. E., et al., “Nutrition and physical activity self-assessment for child care (NAP SACC): results from a pilot intervention,” J. Nutr. Educ. Behav., 39:142-9 (2007); National Association for Sport and Physical Education. Active start: A statement of physical activity guidelines for children birth to five years. Washington, D.C.: NASPE (2002); American Physical Therapy Association. Lack of time on tummy shown to hinder achievement of developmental milestones, say physical therapists. http://www.apta.org/AM/Template.cfm?Section=Home&Template=/CM/ContentDisplay.cfm&ContentID=57947 (2008). Early infancy and childhood interventions geared to risk reduction of overweight and obesity should include education on risks associated to screen time, and on physically active alternatives to screen time to encourage motor development in young children.

Sleep Duration

Since the first report in 1992, suggesting that short sleep duration is associated with childhood obesity, see, Locard E., et al., “Risk factors of obesity in a five year old population: Parental versus environmental factors,” Int. J. Obes. Relat. Metab. Disord. 16:721-9 (1992), multiple observational studies have been identified that link reduced sleeping duration among young children with increased adiposity, overweight, or obesity during infancy, toddler, and the pre-school years, see, Gillman M. W., “The first months of life: a critical period for development of obesity,” Am. J. Clin. Nutr., 87:1587-9 (2008); Monasta L., et al., “Early-life determinants of overweight and obesity: a review of systematic reviews,” Obes. Rev., 11:695-708 (2010); Anderson S. E., et al., “Household routines and obesity in US preschool-aged children,” Pediatrics, 125:420-8 (2010). Recently, shorter sleep duration during infancy (less than 12 hours/day) has been associated with higher BMI z score, skinfold measures, and increased odds of overweight in three year old children. Taveras E. M., et al., “Short sleep duration in infancy and risk of childhood overweight,” Arch. Pediatr. Adolesc. Med., 162:305-11 (2008).

Parenting behaviors surrounding sleep duration in infancy may influence sleeping patterns for life. For example, children of whom do not sleep for at least six hours nightly by age five months have a greater risk of short nocturnal sleep duration later in childhood, see, Touchette E., et al., “Factors associated with fragmented sleep at night across early childhood,” Arch. Pediatr. Adolesc. Med., 159:242-9 (2005); Wolke D., et al., “The incidence of sleeping problems in preterm and fullterm infants discharged from neonatal special care units: an epidemiological longitudinal study,” J. Child Psychol. Psychiatry, 36:203-23 (1995), and one longitudinal study of sleep in children reported that sleep duration for age, compared with “norms,” remained constant for nearly 90% of children age one to ten years, see, Jenni O. G., et al., “Sleep duration from ages 1 to 10 years: variability and stability in comparison with growth,” Pediatrics, 120:e769-e776 (2007). Thus, it appears, albeit from limited data, that sleep duration during infancy sets the stage for sleeping patterns throughout childhood.

Mechanisms to help explain the relationship between sleep and overweight are based on both physiological and behavioral findings. Biochemical markers are limited for infants and young children; however, sleep restriction in adults is associated with increases in the appetite stimulating peptide, ghrelin, and a reduction in the anorexigenic hormone, leptin. Al-Disi D., et al., “Subjective sleep duration and quality influence diet composition and circulating adipocytokines and ghrelin levels in teen-age girls,” Endocr. J., 57:915-23 (2010); Van C. E., et al., “Sleep and the epidemic of obesity in children and adults,” Eur. J. Endocrinol., 159 Suppl 1:S59-S66 (2008); Motivala S. J., et al., “Nocturnal levels of ghrelin and leptin and sleep in chronic insomnia,” Psychoneuroendocrinology, 34:540-5 (2009). Although one study with infants identified that lower cord blood ghrelin was associated with slower weight gain from zero to three month old infants, confirmation from larger studies of infants, addressing the influence of confounding variables, is not currently available. James R. J., et al., “Low cord ghrelin levels in term infants are associated with slow weight gain over the first 3 months of life,” J. Clin. Endocrinol. Metab., 89:3847-50 (2004).

Parental feeding behaviors, related to infant sleeping, may have a strong impact on early and rapid weight gain. The possibility that food, especially bottle feeding and early introduction of complementary food, is used by parents as an

Shared Family Meals

As part of its initiative to prevent and/or reduce childhood obesity, the AAP recommends that families regularly eat meals together (www.aap.org/obesity/families.html) and the frequency of regular family meals is significantly related to the nutritional health and weight in children. Meta-analysis of 17 studies of children (age 2.8 years and older) that examined children's weight status, food consumption, and eating patterns identified a 12% reduction in odds of pediatric overweight (e.g., >85^{th} percentile) with a family meal frequency of three or more meals together per week. Hammons, A., et al., “Is Frequency of Shared Family Meals Related to the Nutritional Health of Children and Adolescents?”, Pediatrics (2011). The majority of studies included children of adolescent age; however, when age was tested as a potential moderator, it was found to be non-significant. Similarly, cross sectional analysis of a nationally representative sample of ˜8550 four year old US children reported that children of whom engaged in eating family meals at least five or more evenings per week were at a 16% decreased risk of obesity (>95^{th} percentile), compared to those consuming fewer family meals together. Anderson S. E., et al., “Household routines and obesity in US preschool-aged children,” Pediatrics, 125:420-8 (2010). Although there is little evidence specifically linking family meal participation of older infants and toddlers to obesity, recent FITS study results indicate high rates of infants eating outside the home, in fast food store restaurants. Family meal time appears to be an important contributor to pediatric overweight for preschool age and older children.

It must be noted that for the aforementioned potentially modifiable parent feeding and related behaviors that correlate with pediatric obesity, for some of the very youngest infants, a fully causal relationship remains to be established. Prospective and well controlled interventional studies, offering a practical and generalizable way to address the feeding and parent related behaviors associated with childhood obesity are urgently needed to address the obesity epidemic.

The above-described factors may be categorized as either modifiable or not modifiable. The modifiable risk factors can then be grouped into 8 categories. In sum, the modifiable risk factors for overweight or obesity may be described as follows: (1) providing breast milk (2) utilizing responsive feeding practices (3) providing nutritious complimentary foods and beverages at the appropriate developmental stage (4) ensuring that the child has adequate sleep (5) excluding sugar sweetened beverages for infants and limiting them for toddlers (6) fostering healthy eating behaviors through shared family meals (7) limiting TV and screen viewing time and (8) providing opportunities for physical activity.

These factors provide the basis for calculating obesity risk and for methods of mitigating the same. They may be inputted into an obesity risk calculator to determine a child's individual obesity risk.

For example, if it is known whether a child is breast fed, whether the caregiver uses responsive feeding methods, whether the child is fed a balanced and healthful diet, or whether the child eats primarily sugary snacks, etc. then it is possible to use that information in a science based algorithm to determine an individual child's risk of becoming obese or overweight.

Evidence for Obesity Prevention Strategies in Childhood

Initially, the focus of childhood research on interventions to curb obesity had been on treatment, after the child was identified as overweight, or diagnosed with weight related medical problems. Thus, many interventions have been directed toward school age children and particularly adolescents, see, Bluford D. A., et al., “Interventions to prevent or treat obesity in preschool children: a review of evaluated programs,” Obesity (Silver Spring), 15:1356-72 (2007), given the persistent prevalence of overweight in this population, see, Ogden C. L., et al., “Prevalence of high body mass index in US children and adolescents,” 2007-2008, JAMA 303:242-9, 2007-2008 (2010); Hedley A. A., et al., “Prevalence of overweight and obesity among US children, adolescents, and adults,” 1999-2002, JAMA, 291:2847-50 (2004). Although current US based guidelines enlist support of pediatricians to obtain BMI measurements during all well care child visits and discuss obesity preventative and/or reductive strategies, many insurance carriers deny claims submitted with “obesity” codes. Klein J. D., et al., “Adoption of body mass index guidelines for screening and counseling in pediatric practice,” Pediatrics, 125:265-72 (2010). Of 677 pediatricians responding to a national survey on pediatric obesity, only 15% reported they are reimbursed for overweight counseling and treatment separately from well child visits, and 56% reported that reimbursement is insufficient. Most of those surveyed (82%) agreed that many patients are not able to pay for uncovered services. Klein J. D., et al., “Adoption of body mass index guidelines for screening and counseling in pediatric practice,” Pediatrics, 125:265-72 (2010). Few obesity treatment strategies with children have been effective and none have longitudinally tracked weight maintenance.

With recognition that efforts may have been misplaced with channeling obesity research toward treatment only, research has shifted toward earlier recognition of excess weight. Taveras E. M., et al., “Weight status in the first 6 months of life and obesity at 3 years of age,” Pediatrics, 123:1177-83 (2009); Stettler N., et al., “Early growth patterns and long-term obesity risk,” Curr. Opin. Clin. Nutr. Metab. Care, 13:294-9 (2010). Yet, the majority of programs have been aimed at school age children, many of whom have an established excess weight status. Most childhood obesity prevention and/or reduction approaches still address the school-age and adolescent populations, and have been met with little success. Anzman S. L., et al., “Parental influence on children's early eating environments and obesity risk: implications for prevention,” Int. J. Obes. (Lond), 34:1116-24 (2010); Baranowski T., et al., “Steps in the design, development and formative evaluation of obesity prevention-related behavior change trials,” Int. J. Behav. Nutr. Phys. Act., 6:6 (2009); Birch L. L., et al., “Preventing childhood obesity: what works?,” Int. J. Obes. (Lond), 33 Suppl 1:S74-S81 (2009). The few preschool age intervention studies and clinical trials with infant populations are described below.

Evidence for Obesity Prevention Interventions in Preschool Children

Recent reviews of studies of preschool obesity prevention and treatment interventions, reveal that worldwide, only eight randomized clinical trials meeting authors' criteria in these reviews have been conducted since 1995. Lanigan J., et al., “Prevention of obesity in preschool children,” Proc. Nutr. Soc., 69:204-10 (2010); Bluford D. A., et al., “Interventions to prevent or treat obesity in preschool children: a review of evaluated programs,” Obesity (Silver Spring), 15:1356-72 (2007); Skouteris H., et al., “Healthy eating and obesity prevention for preschoolers: a randomised controlled trial,” BMC Public Health, 10:220 (2010). Two of the more frequently cited randomized controlled studies of pre-school healthy eating and obesity prevention that are included in review papers and primary research discussion sections have been successful within their targeted population, noted by changes in the frequency of “restrictive feeding” practices and decreased energy intake, see, Harvey-Berino J., et al., “Obesity prevention in preschool native-american children: a pilot study using home visiting,” Obes. Res., 11:606-11 (2003), and increased scores on knowledge feeding scales after intervention, see, Horodynski M. A., et al., “Nutrition education aimed at toddlers: an intervention study,” Pediatr. Nurs., 31:364, 367-4, 372 (2005). However, no significant changes in weight gains were reported.

Another review, focusing on infants and children zero to five years of age, included both non-randomized and controlled trials that aimed to improve diet, increase physical activity and/or achieve behavioral change. Hesketh K. D., et al., Interventions to prevent obesity in 0-5 year olds: an updated systematic review of the literature,” Obesity (Silver Spring), 18 Suppl 1:S27-S35 (2010). In this review, studies (n=23) were conducted within preschools, childcare centers, children's homes, or community settings. Approximately half the trials targeted socioeconomically disadvantaged children (n=12) and three quarters were published from 2003 onward (n=17). The interventions, study design, and study quality were varied, although most were multifaceted in their approach and reported that their interventions were feasible and favorably rated or accepted by the parent/caregiver/childcare participants.

Evidence for Obesity Prevention Interventions in Infancy

Few studies have examined, or are currently investigating the efficacy of interventions for obesity prevention that target infant populations or children less than two years. Ciampa P. J., et al., “Interventions Aimed at Decreasing Obesity in Children Younger Than 2 Years,” Arch. Pediatr. Adolesc. Med., vol. 164 (no. 12) (2010). Only three recent studies assessing specific interventions in early infancy could be identified. A randomized, controlled, pilot trial in the US, with 110 mother-infant dyads, recently reported positive results for their two-component intervention in preventing overweight during infancy. Paul I. M., et al., “Preventing Obesity during Infancy: A Pilot Study,” Obesity (Silver Spring) (2010). Interventions were provided by home-nurse visits consisting of educational content addressing alternative strategies to feeding for soothing a fussy baby and complementary feeding information, a feeding demonstration, and guidance of recognizing hunger and fullness cues. In this study, infants who were provided a “soothe/sleep education intervention” at two to three weeks of life, and “introduction to solid food education” between four to six months of life, realized a significantly lower weight-for-length percentile at one year of age. Despite study limitations of a relatively small sample size, and primarily breast-fed infants, results indicated that the intervention was effective in helping infants achieve healthy growth, likely through the influence of increases in nocturnal sleep duration, delayed introduction of solid foods and increases in consumption of vegetable foods.

A second recently published US pilot study included 80 infants enrolled during the first week of life, and their post-partum mothers, to assess impact of an education program on infant feeding, sleep duration, TV viewing and mothers' responsiveness to their infants satiety cues. Taveras E. M., et al., “First Steps for Mommy and Me: A Pilot Intervention to Improve Nutrition and Physical Activity Behaviors of Postpartum Mothers and Their Infants,” Matern. Child Health J. (2010). In addition, the intervention aimed to influence the mother's postpartum diet, activity, TV and sleep behaviors. After six months of brief pediatrician messages, motivational interviewing/coaching by health educators, and group parenting workshops, significantly fewer intervention infants had been introduced to solid foods, compared to the usual care-control group. Intervention infants viewed less TV, had larger increases in nocturnal sleep duration, and required less settling time than infants provided usual care. No significant differences in infant weight status were detected; however, trends indicated a lower change in weight-for-length z scores and fewer infants were found in the highest quartiles of weight-for-length among intervention, compared to control, infants. Although this non-randomized, pediatrician based, intervention program was not directly effective in influencing maternal postpartum behaviors regarding their own weight, the multicomponent intervention tended to improve infant weight related behaviors employed by the mothers.

A third study enrolled three to ten week old, exclusively formula fed infants that participated in the WIC program. The educational intervention consisted of one session that focused on recognizing signs of infant satiety and limiting formula volume to no more than six oz per bottle. No difference among intervention and control infants with regard to weight gain, formula intake, or parental behavior was realized when assessed at four months. The study was limited by a small sample size and high loss to follow-up. Kavanagh K. F., et al., “Educational intervention to modify bottle-feeding behaviors among formula-feeding mothers in the WIC program: impact on infant formula intake and weight gain,” J. Nutr. Educ. Behav., 40:244-50 (2008).

Ongoing randomized, controlled study protocols of early intervention trials for obesity prevention in infants that address multiple intervention components have been published by at least three groups in Australia, one in London, one in Italy, and another in the US, yet to date, only one study targets infants from birth. Wen L. M., et al., “Early intervention of multiple home visits to prevent childhood obesity in a disadvantaged population: a home-based randomised controlled trial (Healthy Beginnings Trial),” BMC Public Health, 7:76 (2007); Campbell K., et al., “The Infant Feeding Activity and Nutrition Trial (INFANT) an early intervention to prevent childhood obesity: cluster-randomised controlled trial,” BMC Public Health, 8:103 (2008); Daniels L. A., et al., “The NOURISH randomised control trial: positive feeding practices and food preferences in early childhood—a primary prevention program for childhood obesity,” BMC Public Health, 9:387 (2009); Watt R. G., et al., “Effectiveness of a social support intervention on infant feeding practices: randomised controlled trial,” J. Epidemiol. Community Health, 63:156-62 (2009); Groner, J., et al., “Anticipatory Guidance for Prevention of Childhood Obesity: Design of the MOMS Project, http://cpg.sagepub.comcontent/48/5/483 (2009). Participant acceptance of this intervention is reported as positive, and results of impact on obesity prevention are waiting. Wen L. M., et al., “Evaluation of a feasibility study addressing risk factors for childhood obesity through home visits,” J. Paediatr. Child Health, 45:577-81 (2009).

Another exploratory, randomized controlled trial is currently underway in the United Kingdom with infants under eighteen months, and aims to prevent further obesity in high risk infants (those with weight>95^{th} percentile, or a pre-school age sibling with obesity, or a mother with obesity). Preliminary results, published as qualitative pilot data, suggest that this multi-component intervention may serve as a potentially effective approach for obesity prevention within the high risk weaning age child. Barlow J., et al., “Preventing obesity at weaning: parental views about the EMPOWER programme,” Child Care Health Dev (2010).

Current Recommendations

Despite the absence of well documented, evidence based interventions for obesity prevention in pediatric populations, the medical, dietetic, and other scientific communities have taken on the responsibility to put forth recommendations based on the best information available. Since demonstration of causality for most of the factors associated to pediatric obesity remains undocumented, recommendations rely on a Hippocratic and common sense approaches to improve both diet and activity patterns in childhood, with varying emphasis on environmental and social factors that promote “healthy activity and eating patterns.”

In February, 2010, First Lady Michelle Obama initiated the “Let's Move” campaign, with the goal of reducing rates of obesity within a generation and return to a childhood obesity rate of 5% by the year 2030, a rate similar to that of late 1970's. The White House Task Force on Childhood Obesity Report to the President includes a series of specific recommendations, based on four pillars that shape the basis for these recommendations: (1) empowering parents and caregivers; (2) providing healthy food in schools; (3) improving access to healthy, affordable foods; and (4) increasing physical activity. These constitute the most comprehensive set of recommendations, and involve the participation of all stakeholders in our society.

However, the vast majority of recommendations are pertinent to preschool age and older children. Components of the Task Force's recommendations directly relevant to infancy include strengthening prenatal care, promoting breastfeeding, evaluating the impact of chemical influences in the environment, reducing “screen time,” and improving the quality of our nation's child care settings.

The AAP expert committee recommendations provide pediatric overweight guidelines for children beginning at age two, see, Barlow S. E., “Expert committee recommendations regarding the prevention, assessment, and treatment of child and adolescent overweight and obesity: summary report,” Pediatrics, 120 Suppl. 4:S164-S192 (2007), and The ADA recommends no intervention beyond monitoring for children less than age two with excess weight, see, American Dietetic Association. Evidence Analysis Library Evidence-based Pediatric Weight Management Nutrition Practice Guideline, http://www.adaevidencelibrary.com, Accessed December, 2010 (2011); Nicklas T. A., et al., “Position of the American Dietetic Association: nutrition guidance for healthy children ages 2 to 11 years,” J. Am. Diet. Assoc., 108:1038-7 (2008). Guidelines from The Health and Human Services Healthy People 2020 equally focuses primarily on strategies and programs targeting children above two years of age. U.S.Department of Health and Human Services, HealthyPeople.gov. available at: http://www.healthy_people.gov/2020/default.aspx, accessed Jan. 3, 2011 (2011). Given available data, recommendations are based on associated factors, with no demonstrated causality.

Interventions to prevent obesity that start at birth and focus on the diet and eating patterns of infants and toddlers are needed, and have not been studied. While comprehensive approaches dealing with all aspects of the problem at all ages are important and necessary to address this epidemic, including pre gestational interventions in fertile women, and prenatal care, the first two years of life provide a potential window of opportunity like no other to establish feeding, dietary, and behavioral patterns that remain with an individual throughout life. Overweight and obesity are already identifiable in infancy, and a feature of this epidemic. The very early months and years of life are periods of high plasticity. During this critical time, food intake, eating behaviors, and dietary patterns are initiated, quickly transitioned, and can lead to factors already associated with obesity. Anzman S. L., et al., “Parental influence on childrens early eating environments and obesity risk: implications for prevention,” Int. J. Obes. (Lond), 34:1116-24 (2010).

Proposed Methods

As discussed above, the focus of childhood research on interventions to curb obesity had been on treatment and prevention of obesity in school aged children. These efforts have been met with little success. Body weight status of children less than two years of age has been demonstrated to track through the toddler years, and subsequently into adulthood. Interventions to successfully reduce rates of overweight in this young population have not been given adequate attention. Moreover, quantitative feeding recommendations or national food and nutrition guidelines are unavailable for US children, cared for at home, that are less than two years of age. Few studies have examined, or are currently investigating the efficacy of interventions for obesity prevention in infant populations or children less than two years. Ciampa P. J., et al., “Interventions Aimed at Decreasing Obesity in Children Younger Than 2 Years,” Arch. Pediatr. Adolesc. Med., vol. 164 (no. 12) (2010). Only three recent studies assessing specific interventions in early infancy could be identified. Paul I. M., et al., “Preventing Obesity during Infancy: A Pilot Study,” Obesity (Silver Spring) (2010); Taveras E. M., “Racial/ethnic differences in early-life risk factors for childhood obesity,” Pediatrics, 125:686-95 (2010); Kavanagh K. F., et al., “Educational intervention to modify bottle-feeding behaviors among formula-feeding mothers in the WIC program: impact on infant formula intake and weight gain,” J. Nutr. Educ. Behav., 40:244-50 (2008). Only one study showed a significant effect on weight status at one year. Paul I. M., et al., “Preventing Obesity during Infancy: A Pilot Study. Obesity,” (Silver Spring) (2010). There remains a need to develop an effective intervention to promote appropriate growth through the first two years of life.

Two factors are particularly important in addressing issues of overweight and obesity in children two years of age and younger. The first factor is the need to convey information regarding a child's individual risk of obesity to a parent or caregiver, and the second is the need for a personalized approach to maximize the efficacy of the methods.

The ability to calculate an individual child's risk based on how the caregiver addresses modifiable risk factors for childhood obesity provides the caregiver with essential information, allowing the caregiver to make informed choices. The multi-component feeding systems/methods of the present disclosure are non-face-to-face education systems targeted to first-time mothers of all race/ethnicities and socio-economic statuses designed to provide tailored (personalized) behavioral guidance to decrease a child's risk being of overweight or obese. The personalized knowledge of their child's risk allows for the caregiver to better prevent the child from becoming obese. The multi-component feeding system has four major components: educational content, tools to support the implementation of the content delivered sequentially by an infant's developmental stage, support services to provide guidance, and an obesity risk calculator to provide the child's individualized risk information to the caregiver.

The first component is the educational component which includes core messages addressing at least the eight actionable and modifiable risk factors involved with obesity and being overweight. The factors, (1) providing breast milk, 2) utilizing responsive feeding practices, 3) providing nutritious complementary foods and beverages at the appropriate developmental stage, 4) ensuring that the child has adequate sleep, 5) excluding sugar sweetened beverages for infants and limiting them for toddlers, 6) fostering healthy eating behaviors through shared family meals and mealtime routines, 7) limiting TV and screen viewing time, 8) providing opportunities for physical activity, are conveyed to the parent or caregiver through a variety of means.

The educational component need not include solely the listed eight factors. A plurality of messages related to actionable and modifiable factors associated to childhood obesity may be delivered. In an embodiment, there may be 1, 2, 3, 4, 5, 6, 7, 8, or more messages. The messages also need not be restricted to solely what the factors are. The messages can include relevant knowledge, instruction, facilitators and motivators, and ways to overcome barriers needed to facilitate adoption of each core message.

The messages may also be tailored to the individual receiving the message. Personalized education encourages the parent or caregiver to closely follow the information and guidance provided.

The messages in the educational component are not delivered randomly. They are delivered sequentially by an infant's developmental stage, beginning in the 3^{rd} trimester of pregnancy. The sequence is anticipatory of the developmental milestone when these factors typically occur (e.g., a message on introduction of solid foods will be delivered during the Birth+ stage, before solids foods are introduced in the Supported Sitter stage).

The second component is the provision of tools to assist with the initiation and maintenance of the delivery of educational content. The tools may include, for example, message delivery channels such as print, telephone, dedicated website, videos, and mobile applications. Additional tools such as a menu planner, visuals of serving sizes, and growth charts/tracking tools may also be provided through the website and mobile applications, or in print form.

The third component includes the provision of support services to augment and supplement the information in the messages. Additional support may be provided in the form of a registered dietitian and/or certified lactation specialist through a toll free phone service, a web service, video chat, or the like.

The fourth component is the obesity risk calculator. The obesity risk calculator allows the mother or other caregiver to understand the exact level of a risk a child of 0 to 2 years age has for being obese. The calculator also allows for understanding of exactly which of the above-described modifiable risk factors are at play in generating that level of obesity risk. With that information, a mother or other caregiver can be provided with a tailored and personalized plan to mitigate obesity risk. The obesity risk calculator works through the input of information related to the decisions the caregiver makes for the child with respect to eight key modifiable risk factors. These eight modifiable risk factors are similarly discussed in the education component such that the information gained from the education component can be seen to be directly relevant to a child's individual obesity risk. The eight factors that may be used to calculate the obesity risk are: 1) whether the caregiver feeds the child breast milk, 2) whether the caregiver feeds the child using responsive feeding practices, 3) whether the caregiver provides nutritious complementary foods and beverages at the appropriate developmental stage, 4) whether the caregiver ensures that the child has adequate sleep, 5) to what degree the caregiver excludes sugar sweetened beverages for infants and limits them for toddlers, 6) whether the caregiver fosters healthy eating behaviors through shared family meals and mealtime routines, 7) how much time the caregiver allows the child to spend watching TV or having other screen viewing time, 8) and finally how much of an opportunity the caregiver provides for physical activity for the child. Information is collected regarding each of eight modifiable risk behaviors in anticipation of the age-appropriate stages and that information is used as inputs into the obesity risk calculator to determine a child's individual risk.

At regular intervals, a mother or other caregiver will be pushed to the obesity risk calculator to evaluate the child's risk individual risk of being overweight or obese at any point within the child's first two years of age. The calculator has two sub-components. The first sub-component is a simple, short questionnaire that asks the mother about her current level of performing the modifiable risk factors along with basic biological or demographic information such as mother's body mass index, level of education, etc. Anywhere from one to all of the modifiable risk factors are assessed depending on the child's age.

The second sub-component is a science-based algorithm for determining the child's individual risk of overweight or obesity within the first two years of age. Responses from the questionnaire items are inputted into the algorithm, and the output is the child's percent chance of becoming overweight or obese within the first two years of age.

The obesity risk calculator provides the overall risk for an individual child. Additionally the tool identifies the specific risk from the caregiver's decisions regarding each modifiable risk factor that is applicable to the developmental stage of the child. The information is then incorporated into the other three components going forward. The multi-component feeding system uses the output from the algorithm to develop a tailored (personalized) behavioral guidance plan for the mother or caregiver including alerting the mother or caregiver to the identified risk factors and then pushing her to specific educational content and tools related to the identified risk factors. Modules and core messages not related to the child's identified risk factors will still be delivered in the same anticipatory and sequential manner to help facilitate adoption of those new core messages.

Regular re-assessment using the calculator will be pushed to the mother or caregiver to monitor changes in the individual child's risk of overweight or obesity, allowing for continual optimization of the behavioral guidance plan for the individual child.

Mothers or caregivers may enter the system during the third trimester of pregnancy and use the obesity risk calculator component in preparation for the child's birth. Alternatively, the system can be entered after a child is born. In these cases, the system first pushes a mother or caregiver to use the Obesity Risk Calculator to determine the child's current risk of overweight/obesity. Once that is known, the mother or caregiver can then enter the system and receive the first tailored (personalized) behavioral guidance plan. Based on the child's age, the mother or caregiver will begin receiving the educational modules that are appropriate to deliver the new core messages in an anticipatory and sequential manner to facilitate adoption of the new core messages.

The information gained from the obesity risk calculator may be displayed not only to a parent or caregiver, but may also be shared or communicated to a doctor or other health professional. The information thus could be used to tailor medical care for the child and to reinforce advice given by the health care professional to the caregiver.

The skilled artisan will appreciate that the results of the obesity risk calculation may be conveyed to a caregiver or health care professional in a variety of ways. The information may be presented in a graphic, or as a chart, in a written explanation, etc. The information may be sent to the caregiver or health care professional by text message, over email, through a secure website, or through other similar means.

One advantage of the disclosed personalized multi-component feeding systems/methods, is that it is the first system/method to address all eight modifiable risk factors associated with obesity in an individually optimized way via the obesity risk calculator.

Another advantage of the multi-component feeding systems/methods is that it is an efficacious system that uses personalized anticipatory guidance and beginning before birth to produce lower BMI at two years and develop positive feeding practices and feeding related practices at two years that will provide protection against obesity throughout childhood and adulthood. Another advantage of the present systems/methods is that the personalized multi-component feeding system can be delivered by any public health program to prevent obesity because it is a non-face-to-face intervention that requires minimal personnel training and ensures high treatment fidelity and cost-effectiveness. Yet another advantage of the present systems/methods is that the personalized multi-component feeding system can be delivered to any population group (e.g., race/ethnicity, SES status) to prevent obesity.

In addition to being easy and efficient to use, the present methods provide many advantages to a user of same. For example, with respect to breastfeeding, the present methods can help to increase rates of breastfeeding initiation, provide longer duration of exclusive breastfeeding, and provide longer duration of any breastfeeding. With respect to introduction to complementary foods, the present methods can help to decrease early introduction of solid foods (<4 months), decrease early introduction of juice (<6 months), and increased introduction of meat at six months for breastfed children.

Regarding diet quality, the present systems/methods can help to provide decreased frequency of meals and snacks at fast-food restaurants, increased proportion of energy as fruit, increased consumption of fruit, increase proportions of energy as vegetables, and increase consumption of vegetables, in general. Specifically, the present methods can help to increase consumption of dark green vegetables including, for example, broccoli, spinach and other greens, and romaine lettuce, and increased consumption of deep yellow vegetables including, for example, carrots, pumpkin, sweet potatoes, and winter squash. Additionally, the methods can help to increase the consumption of other vegetables including, for example, artichoke, asparagus, beets, Brussels sprouts, cabbage, cauliflower, celery, cucumber, eggplant, green beans, lettuces, mushrooms, okra, onions, pea pods, peppers, tomatoes/tomato sauce, wax/yellow beans, and zucchini/summer squash, and increase the consumption ratio of dark green and deep yellow vegetables to starchy vegetables such as, but not limited to potatoes, corn, green peas, immature lima beans, black-eyed peas (not dried), cassava, and rutabaga. Generally speaking, the present systems and methods can help to provide increased variety of vegetables based on the categories of dark green, deep yellow, other, and starchy.

Additionally, the present methods can help to increase the proportion of energy as whole grains, and to increase consumption of whole grains. Decreased consumption of sweetened beverages, dessert foods, salty snacks, and high-fat, low nutrient-dense foods, and high-sodium, high-fat processed meats is also a benefit of the present systems and methods.

Further, with respect to diet quantity, the present methods help to regulate an appropriate caloric intake (number of kcal/kg/day), an appropriate macronutrient distribution (% of total energy), and appropriate micronutrient intakes (usual intake≧EAR).

Even further, in addition to prevention and/or reduction of obesity, the present methods may also be helpful with respect to other medical illnesses. For example, the present methods may also help to prevent and/or reduce the risk of type 2 diabetes, hypertension, heart disease, chronic diseases, Syndrome X, etc.

A yet further advantage of the personalized multi-component feeding system is that the obesity risk calculator may be used independently by health care providers to improve patient counseling. The providers can use the results from the calculator personalize and tailor the advice given to their patients, allowing the providers to achieve better outcomes in preventing and reducing childhood obesity. If a report is generated by the obesity risk calculator, the data presented may be delivered to any health care providers that care for the child, as well as to the caregiver.

With respect to a first component of the present methods, core messages related to actionable and modifiable facts associated to childhood obesity may be delivered to a caregiver and an infant. The core messages may be focused on actionable, potentially modifiable, parent or caregiver related feeding behaviors. Examples of core messages are summarized at Table 2 and are divided into two types of messages. The skilled artisan will appreciate, however, that other similar core messages may be provided and other types, or categorizations, of message may be used. The message may include Feeding and Nutrition Core Messages. Examples of these messages may include the following: provide breast milk, provide nutritious complementary foods and beverages at the appropriate developmental stage, and, exclude sugar sweetened beverages for infants and limit them for toddlers. The messages may also include Feeding Related Behavior Core Messages. Examples of this type of message may include the following: ensure that the child has adequate sleep, foster healthy eating behaviors through shared family meals and mealtime routines, limit TV and screen viewing time, provide opportunities for physical activity.

The messages may include sub-messages. For example, a mother or caregiver can be instructed to provide nutritious complementary foods and beverages at the appropriate developmental stage as a first level message. The mother or caregiver can then be told, for example, that starting at two months of age to limit the baby's intake of juice and sweetened beverages, or at 4 months of age, to also minimize the number of meals that the baby takes away from home. The skilled artisan would recognize that the sub-messages can encompass any nutritionally and developmentally appropriate message associated with the subject matter of the core message. Indeed, the skilled artisan will appreciate that the sub-messages are not limited to those examples set forth herein.

TABLE 2
Examples of Timing of Core Message Delivery

| | Time Intervention Provided | | | | | | | |
|---|---|---|---|---|---|---|---|---|
| | 3rd | | | | | | | |
| | Trimester | Birth | 1 mo. | 2 mos. | 3 mos. | 4 mos. | 5 mos. | 6 mos. |
| Feeding and Nutrition Core | | | | | | | | |
| Messages: | | | | | | | | |
| Breastfeed your baby. | x | x | x | x | x | x | x | x |
| Introduce your baby to solid foods | | | | x | x | x | x | x |
| and drinking from a cup at the | | | | | | | | |
| appropriate developmental stage. | | | | | | | | |
| Limit your baby's intake of juice | | | | x | x | x | x | x |
| and sweetened beverages. | | | | | | | | |
| Minimize the frequency of food | | | | | | x | x | x |
| and meals away from home. | | | | | | | | |
| Feeding Related Behavior Core | | | | | | | | |
| Messages: | | | | | | | | |
| Feed your baby based on hunger | | x | x | x | x | x | x | x |
| and satiety cues. | | | | | | | | |
| Include your baby at family meals. | | | | | | | | x |
| Limit television and screen viewing | | | | | | x | x | x |
| time. | | | | | | | | |
| Your baby should have adequate | | | | x | x | x | x | x |
| sleep. | | | | | | | | |
| Provide the opportunity for your | | | | | | x | x | x |
| baby to be physically active. | | | | | | | | |

| | Time Intervention Provided | | | | | |
|---|---|---|---|---|---|---|
| | 7 mos. | 8 mos. | 9 mos. | 10 mos. | 11 mos. | 12 mos. |
| Feeding and Nutrition Core | | | | | | |
| Messages: | | | | | | |
| Breastfeed your baby. | x | x | x | x | x | x |
| Introduce your baby to solid foods | x | x | x | x | x | x |
| and drinking from a cup at the | | | | | | |
| appropriate developmental stage. | | | | | | |
| Limit your baby's intake of juice and | x | x | x | x | x | x |
| sweetened beverages. | | | | | | |
| Minimize the frequency of food and | x | x | x | x | x | x |
| meals away from home. | | | | | | |
| Feeding Related Behavior Core | | | | | | |
| Messages: | | | | | | |
| Feed your baby based on hunger | x | x | x | x | x | x |
| and satiety cues. | | | | | | |
| Include your baby at family meals. | x | x | x | x | x | x |
| Limit television and screen viewing | x | x | x | x | x | x |
| time. | | | | | | |
| Your baby should have adequate | x | x | x | x | x | x |
| sleep. | | | | | | |
| Provide the opportunity for your | x | x | x | x | x | x |
| baby to be physically active. | | | | | | |

Time Intervention Provided

| | 14 mos. | 16 mos. | 18 mos. | 20 mos. | 22 mos. | 24 mos. |
|---|---|---|---|---|---|---|
| Feeding and Nutrition Core | | | | | | |
| Messages: | | | | | | |
| Introduce your toddler to solid | x | x | x | x | x | |
| foods and drinking from a cup at | | | | | | |
| the appropriate developmental | | | | | | |
| stage. | | | | | | |
| Limit your toddler's intake of juice | x | x | x | x | x | |
| and sweetened beverages. | | | | | | |
| Minimize the frequency of food | x | x | x | x | x | |
| and meals away from home. | | | | | | |
| Feeding Related Behavior Core | | | | | | |
| Messages: | | | | | | |
| Feed your toddler based on | x | x | x | x | x | |
| hunger and satiety cues. | | | | | | |
| Include your toddler at family | x | x | x | x | x | |
| meals. | | | | | | |
| Limit television and screen viewing | x | x | x | x | x | |
| time. | | | | | | |
| Your toddler should have | x | x | x | x | x | |
| adequate sleep. | | | | | | |
| Provide the opportunity for your | x | x | x | x | x | |
| toddler to be physically active. | | | | | | |

As shown in Table 2, each of the core messages may be delivered to the mother or caregiver at a specific time and in a specific order. The skilled artisan will appreciate, however, that the specific timing set forth in Table 2 should be slightly altered to fit the needs of each specific infant/toddler/parent, etc, based on the results of the obesity risk calculator. As mentioned above, however, the core messages are delivered in an anticipatory manner and sequentially with respect to an infant's developmental stage. For example, the core messages may initially be delivered sequentially by an infant's developmental stages beginning in the 3^{rd} trimester. In other words, the sequence is anticipatory of the developmental milestone when these factors typically occur (e.g., message on introduction of solid foods will be delivered during the Birth+ stage at zero to four month, before solid foods are introduced in the supported sitter stage at 4 to 6 months). Examples of different developmental milestones/stages are set forth below in Table 3.

TABLE 3
Developmental Milestones/Stages

| | Birth + | Supported Sitter | Sitter |
|---|---|---|---|
| | (e.g., 0-4 mos.) | (e.g., 4-6 mos.) | (e.g., 6+ mos.) |
| Gross Motor | Little truncal (vertical) | Controls the head | Sits independently |
| Development | stability | Truncal stability to sit | Truncal stability |
| | | with support | |
| Fine Motor | Reflexive grasp only | Sustained voluntary | Primitive squeeze/ |
| Development | | grasp | Palmar grasp |
| | | | Begins to rake (with |
| | | | fingers) food toward self |
| Oral Motor | Rooting and sucking | Moves puree food | Develops tongue wave |
| Development | Early gag reflex | forward and back with | and lip close |
| | | tongue to swallow | Begins chewing |
| | | Loss of extrusor reflex | movements using up and |
| | | (tongue thrust) | down movement of jaw |
| | | Gag reflex locus moves | (“munching”) |
| | | from the mid portion to | Uses upper lip to help |
| | | the posterior of the tongue | clear food off of spoon |
| | | | Able to keep thicker |
| | | | purees in mouth |
| | | | Can drink from a cup hel [symbol] |
| Cognitive | Enjoys bold colors | Indicates an appetite for | Reaches for food or |
| Development | Prefers looking at people | satiety | spoon when hungry |
| | Smiles, frowns, grimaces | Moves head forward to | Slows down eating when |
| | | reach spoon when hungry | full |
| | | or away when full | Clenches mouth shut |
| | | | when full |
| Appropriate | Breast milk | Breast milk | Breast milk |
| Products | Iron fortified formula | Iron fortified single grain | Single or mixed grain |
| | | infant formula | iron fortified infant cereal |
| | | Single ingredient pureed | Pureed foods |
| | | foods | Pureed meats |
| | | | Yogurt |
| | | | Fruit juice |
| | Crawler | Toddler | Preschooler |
| | (e.g., 8+ mos.) | (e.g., 12+ mos.) | (e.g., 24+ mos.) |
| Gross Motor | Crawls with stomach off | Stands alone | Runs well without falling |
| Development | the floor | Walks with and without | Sits in a booster seat or |
| | May pull self to stand | support | at table |
| | Struggles to get object out | | |
| | of reach | | |
| Fine Motor | Begins to self-feed Finger | Feeds self easily with | Manipulates small objects |
| Development | Foods as pincer grasp is | fingers | Practicing/mastering |
| | developing | Fine Pincer Grasp | utensils |
| | Begins to manipulate | developed | Eats/drinks with minimal |
| | objects correctly (spoon) | Begins to use spoon and | spilling |
| | but does not use it for self | fork | Holds and drinks from a |
| | feeding yet | | cup |
| | Explores objects with | | |
| | hands and mouth | | |
| | Can hold lidded up | | |
| | indepen | | |
| Oral Motor | Developing tongue | Able to drink from a cup | Refined drinking skills |
| Development | lateralization used to move | or straw | Chews skillfully and |
| | food to jaw line for mashing | Skillful at chewing of | efficiently |
| | and chewing | complex foods | Needs less time and |
| | Begins to use jaw to mash | Bites through a variety of | fewer chews to finish a |
| | and chew food | textures | mouth full of food |
| | Begins to track and | Coordinated tongue | Molars present |
| | sort pieces of food in the | movement | Uses tongue to clear food |
| | mouth | First year molars begin | from lips |
| | | erupting | |
| Cognitive | Reaches for food when | Rejection of new foods | Follows simple |
| Development | hungry | Expresses desire for | instructions |
| | Shows excitement for food | specific foods | Begins to sort by shape |
| | when hungry | Follows one step | and color |
| | Shakes head to say “no | commands | Growing independence |
| | more” when full | Plays with food and | Cautious about new |
| | | throws it when full | foods |
| | | Uses words like “all done” | Prefers familiar foods |
| | | Can lead parent by | |
| | | pointing | |
| Appropriate | Breast milk | Whole 2% milk | Whole 2% milk |
| Products | Cereal snacks | Cereal | Cereal |
| | Single or mixed grain iron | Table foods | Table foods |
| | fortified infant cereal | Diced meats, legumes, | Diced meats, legumes, |
| | Zweiback | vegetables, fruits | vegetables, fruits |
| | Pureed/mashed foods | Yogurt and dairy snacks | Yogurt and dairy snacks |
| | Pureed/mashed meats | Toddler meals | Toddler meals |
| | Yogurt and dairy snacks | | |
| | Fruit juice, iced fruits and | | |
| | vegetables | | |

[symbol]

indicates data missing or illegible when filed

Additionally, another component of the present methods includes the delivery of the core messages in the form of media tools. The media tools that help to support educational module content may be selected from the group consisting of a visual or written description of hunger and satiety cues, a menu planner, sample serving sizes, breastfeeding tracker, growth tracking tools, or combinations thereof. For example, the media tools may be videos of hunger and satiety cues appropriate to each developmental stage, a menu planner, visuals of typical serving sizes, printed growth charts, breastfeeding trackers, and growth tracking tools, etc. The skilled artisan will also appreciate that the tools should also be tailored to the parent and caregiver in question. For example, if a mother has difficulty planning serving sizes, the images of serving sizes and examples would be provided. If serving size is, in contrast, not an issue for a particular mother or caregiver, then those tools would be less emphasized in favor of tools related to higher risk factors based on the results of the obesity risk calculator.

The core messages and tools can be delivered via one or a combination of media sources including, for example, written (e.g., US mail delivered), telephone calls, web-based (e.g., email, dedicated websites, etc.), video, mobile phone applications, computer implemented programs, and other such sources. Indeed, the skilled artisan will appreciate that the media sources used to deliver the messages and tools is not limited to those examples set forth herein. The skilled artisan will appreciate that the methods of delivery for the message and tools may also be tailored to the particular parent or caregiver of a child to focus on the delivery methods that most successfully reach a particular individual.

In an embodiment, additional support sources may be provided to help a caregiver or mother stay on track with the delivery of the messages. For example, additional support sources may include a registered dietitian and/or certified lactation specialist. The dietitian and/or certified lactation specialist may be available to a caregiver or mother to provide advice, answer questions and to motivate the caregiver or mother to continue implementing messages. In an embodiment, the dietitian and/or certified lactation specialist will be available to provide telephone support through a toll-free number provider to the mother. The dietitian or specialist may also be available through web chat, or video chat or other similar technology.

As mentioned previously, the core messages and tools may be delivered at a time that is synchronized to each infant's developmental milestones. For example, the core messages and tools may be anticipatory such that the core messages and tools are delivered prior to the developmental stage that each infant will be approaching. The core messages and tools may also be delivered sequentially, addressing only the diet, feeding, and feeding behaviors of relevance to the anticipated developmental stage. By delivering the core messages and tools in an anticipatory, sequential manner, a caregiver is not trying to change an already developed behavior but, rather, is trying to set the behavior before it occurs. This is in direct contrast to most prior art methods for reducing or preventing childhood obesity, which are directed to changing behavior instead of setting a pattern before the behavior occurs. Examples of educational intervention time-frame and focus are provided on Table 2 above. The timing of delivery will necessarily also be influenced by the results from the obesity risk calculator.

Parents or caregivers will be encouraged to use the obesity risk calculator to tailor the approach to preventing obesity and overweight conditions for their children at various times throughout the process. For example, the parent may be asked to use the obesity risk calculator during the third trimester of pregnancy, and again when the child has reached certain developmental milestones. The skilled artisan will appreciate that the timing for use of the obesity risk calculator can vary depending on the needs of the child and parent or caregiver.

The obesity risk calculator involves two parts: a short questionnaire addressing background information and about the current level of performance for each of the modifiable risk factors. The questionnaire may be filled out in paper form, electronically, or over the phone.

The results are then entered into a science-based algorithm for determining the child's individual risk. The skilled artisan will appreciate that the risk calculated is dependent on the results of the questionnaire and the degree to which the parent or caregiver is acting to minimize risk from each of the identified, modifiable factors. The result calculated from the algorithm is the child's percent chance of becoming overweight or obese during the first two years of life, as well as what the specific risk is from each of the modifiable risk factors.

The skilled artisan will appreciate that the results are then used to tailor and personalize the present systems/methods to identify the highest risk modifiable factors and encourage the parent or caregiver to mitigate the risk from the identified factor. The personalized information from the calculator allows for a particularly efficient and effective system or method for preventing obesity or overweight conditions in children under age two.

The skilled artisan will also appreciate that the systems/methods disclosed may also be implemented through the use of a computer. The systems/methods may be efficiently performed using a computer and a computer readable medium containing the necessary data and instructions for using a computer running appropriate software to implement at least one algorithm used to calculate obesity risk. In an embodiment, one algorithm is used.

Information collected from a child's caregiver can be stored in a database on a computer. The information collected on the child's general health background, demographic and biological information, as well as information collected relating to a caregiver's current level of performing each modifiable risk factor associated with childhood obesity can be input into a computer implemented program and processed using the science based algorithm to calculate the child's percent chance of becoming overweight or obese within the first two years of age. The program implementing the algorithm can also calculate the specific risk for the child from each modifiable risk factor.

Further, a computer may be used to generate a behavioral guidance plan tailored to an individual child. The skilled artisan will note that a computer program could generate a guidance plan optimized to the child's calculated percent chance of becoming overweight or obese and the child's specific risk level from the modifiable factors.

In summary, it is clear that a health crisis of epidemic proportions associated to obesity exists both globally and in the US. Undoubtedly, the solution to this crisis will require participation of all segments of society, government, and the private sector to address the individual as well as the environmental aspects that govern energy intake and physical activity.

This disclosure summarizes the magnitude of the problem of overweight in childhood, and the need for early intervention. A large and growing body of literature indicates that the genesis of the problem occurs in early life. As of today, the vast majority of the efforts for ameliorating the problem have focused on management and therapy of obese individuals and their complications. Clearly, there are genetic, maternal, and general environmental factors that will need to be addressed, some of which may not be modifiable, others which may come about more slowly. Until now, a great deal of attention is placed on foods (to modify their caloric density and composition). This is too little. Less attention has been placed on the overall diet and the individual and environmental modifiable factors that govern energy intake and consumption in early life. More recently, serious effort has been placed on potential interventions in school age children, and older populations. While these are still needed, this is too late. It is increasingly clear that feeding patterns, dietary habits, and related behaviors are established very early in life, but little emphasis has yet been focused on research of potentially preventive interventions that are more likely to yield greater efficacy (i.e., interventions in infancy, starting at birth, or before).

There are a great many factors associated with obesity, including those associating factors in infancy with obesity, but the documentation of causality remains unclear. Applicant has used some of these factors to develop a unique, and practical approach to large-scale prevention of obesity focusing on the child, with interventions starting with maternal education before birth and during the life stage most susceptible for adequate programming of behaviors related to diet that can have long term consequences.

Indeed, Applicant has developed personalized systems/methods to systematically address all eight key modifiable factors associated with obesity. Applicant's systems/methods provide a tailored (personalized) behavioral guidance system related to the eight modifiable risk factors to reduce a child's risk of obesity and to help mothers or other caregivers develop positive feeding practices and feeding related practices in the child's first two years of life and beyond.

These systems/methods are tailored to the individual child's risk as identified through the obesity risk calculator and the messages, tools, and services made available to address that risk can be customized to address the needs of the of the parent or caregiver as well based on the results from the calculator. The systems/methods in fact provide additional information regarding obesity risk that can even be used independently of the rest of the system/methods by, for example, a health care provider to provide personalized treatment and counseling. Additionally, the present disclosure provides intervention to deliver education in a tailored, sequential and anticipatory way that will influence behavior choices before the behavior manifests as to prevent negative behaviors from ever forming (e.g., from pregnancy decisions about breastfeeding through the first two years of life). Lastly, the present disclosure provides an intervention that is completely non-face-to-face and therefore more cost-effective than face-to-face interventions, making it easier to scale-up and affect large populations.

### Example

Applicant has designed a prospective, randomized, controlled clinical trial in a large, nationally representative, healthy infant population, starting from the third trimester of pregnancy, which assesses the effects of a personalized, tailored, multi-component feeding system based on calculated obesity risk on diet, growth, and other health outcomes, through the first two years of life, and in later childhood. The multicomponent feeding system based on calculated obesity risk is a complete, nutritionally and developmentally appropriate program, scientifically designed to promote healthy dietary intake, feeding habits, and growth, in infancy and beyond tailored to the individual child and parent or caregiver. Specifically, the study will utilize an anticipatory guidance approach to deliver core feeding messages, strategies, and practical parent feeding suggestions that are associated with a healthy diet and prevention of childhood obesity based on the eight modifiable factors associated to obesity. These core feeding messages are: (1) provide breast milk, (2) utilize responsive feeding practices, (3) provide nutritious complementary foods and beverages at the appropriate developmental stage, (4) ensure that the child has adequate sleep, (5) exclude sugar sweetened beverages for infants and limit them for toddlers, (6) foster healthy eating behaviors through shared family meals and mealtime routines, (7) limit TV and screen viewing time, (8) provide opportunities for physical activity. The messages will be adequately timed, anticipating the infant's developmental stage (e.g., “birth+” at zero to four months, “supported sitter” at four to six months, “sitter” at six+ months, “crawler” at eight+ months, “toddler” at twelve+ months, and “preschooler” at 24+ months). The evidence based feeding guidelines will focus on education, encouragement and active support of breastfeeding, appropriate introduction of complementary foods, positive parent feeding practices and healthy, independent eating and activity behaviors for infants and young children, as shown in Table 2 above. The messages, tools, and support provided will be tailored to the individual child based on the results from calculating the obesity risk for that child. The risk will be calculated by a short questionnaire given to the parent or caregiver addressing background and actions taken regarding each risk factor. The questionnaire results will be inputted into a science-based algorithm and will generate the child's individual risk of becoming obese by age two.

Research Objectives and Aims

To develop and implement a personalized, evidence-based multi-component feeding system for the first two years of life, which optimizes diet and feeding practices, based the actionable and modifiable factors associated with childhood obesity. The feeding system will be implemented based on each child's individualized obesity risk, as calculated from a short questionnaire including background information and each of the eight modifiable risk factors discussed above. The answers from the questionnaire are inputted into an algorithm, generating the child's risk of becoming obese during the first two years of life. During the study, Applicant will document the efficacy of the system with respect to the following: (i) improving diet and feeding patterns during and after the intervention period, and potentially for years; and (ii) infant growth (e.g., BMI) in infancy and early childhood. The study of the present example aims to implement and evaluate a personalized, multi-component feeding system based on individual obesity risk as compared to a non-intervention control, through the first two years of life, in a prospective, controlled and randomized fashion as well as compared to general intervention not tailored to an individual child.

Study Hypotheses

Compared to a control group, Applicant believes that the intervention group of infants and toddlers will demonstrate both primary and secondary outcomes. The primary outcomes include, for example, lower rate of weight gain, weight for length, and/or BMI. The secondary outcomes include, for example, increased initiation rates and duration of breastfeeding; improved diet quality (e.g., energy, food groups); consumption of solid foods at a significantly later introduction age; decreased intake and/or delayed introduction of juice, sweetened beverages, dessert foods, and high fat, low nutrient foods; increased fruit, vegetable and fiber consumption; appropriate caloric and macronutrient distribution; improved biochemical markers of nutritional status; achievement of recommendations for hours of nightly sleep; exhibit decreased TV/screen viewing time with more physically active play time; less meals and snacks at fast-food restaurants; and participation in family meals on a more frequent basis. Applicant also believes that as compared to general intervention not tailored to the individual child's obesity risk, the presently tested system will be more effective at preventing obesity or overweight conditions in infants and toddlers.

Compared to a control group, Applicant believes that the intervention group parents will demonstrate: increased knowledge with respect to infant and child diet and feeding behaviors; and initiation and maintenance of positive feeding behaviors including, for example, increased recognition and response to infant cues of hunger and satiety and the division of responsibility in feeding, awareness of their use of restrictive feeding practices. Applicant believes that the group receiving the system based on the child's calculated obesity risk and tailored to that risk will show the greatest level of improvement in knowledge with respect to infant and child diet and feeding behaviors; and initiation and maintenance of positive feeding behaviors.

Overall Study Design

The study is designed as a prospective, randomized, controlled trial of mother-infant dyads, nationally representative of the US population. For this purpose, first-time mothers of a nationally representative sample, will be stratified according to their WIC participation status during their last trimester of pregnancy, and randomized to either the multi-component feeding system using an obesity calculator to tailor the system to the child's risk, to a general intervention method not tailored to a child's individual obesity risk, or to a control group which will be provided usual care practice standards.

The intervention will commence during the third trimester of pregnancy when breastfeeding encouragement and education are provided, and the initial phase of the study will end when the child is two years of age. Potential continuation of the study to four years, and possibly longer, will be considered, to confirm that initial outcomes are sustained.

Personalized Multi-Component Feeding Intervention Group:

The intervention comprises education and instructional modules, delivered to mothers beginning at 30-36 weeks gestation and followed by delivery of education modules at birth, and subsequently, not less than every two months, until the child is two years of age. The multi-component feeding education system may include education modules that deliver specific, core messages, and media tools to support the education module content. The intervention will be based on the results of the obesity risk calculator; comprising two sub-components. The mothers will fill out a short questionnaire at the beginning of the study including background information and information about their current practices related to the eight above-listed modifiable risk factors. The results will then be inputted into a science-based algorithm to calculate the child's risk of becoming obese by the age of two as well as a breakdown of risk by modifiable risk factor. The information will then be used to tailor the system to focus on the risk factors most applicable to the particular mother-child dyad.

The mothers will be pushed into the obesity risk calculator at regular intervals (at each visit or phone call) and the system will be continually modified based on the results of the calculator.

The education modules may be simple, practical, and specifically focused on addressing factors significantly associated to childhood obesity, based on published observational research. The core messages will also be focused only on actionable, potentially modifiable, parent related feeding behaviors.

The media tools that help to support educational module content may include, for example, videos of hunger and satiety cues appropriate to each developmental stage, a menu planner, visuals of serving sizes, growth charts, breastfeeding trackers, and growth tracking tools, etc. The delivery of core messages and tools will be completed via a combination of vehicles: written (e.g., US mail delivered), web-based, video, and mobile phone applications.

The core messages and tools may be delivered at a time that is synchronized to each infant's developmental milestones. For example, the core

A summary of educational intervention time-frame and focus is provided on Table 4 below. A Registered Dietitian and/or certified lactation specialist will be available to provide reactive telephone support on a 24 hour basis.

TABLE 4
Timing of Core Message Delivery and Outcome Measurements.

| | Time Intervention Provided | | | | | | | |
|---|---|---|---|---|---|---|---|---|
| | 3rd | | | | | | | |
| | Trimester | Birth | 1 mo. | 2 mos. | 3 mos. | 4 mos. | 5 mos. | 6 mos. |
| Feeding and Nutrition Core | | | | | | | | |
| Messages: | | | | | | | | |
| Breastfeed your baby. | x | x | x | x | x | x | x | x |
| Introduce your baby to solid foods | | | | x | x | x | x | x |
| and drinking from a cup at the | | | | | | | | |
| appropriate developmental stage. | | | | | | | | |
| Limit your baby's intake of juice and | | | | x | x | x | x | x |
| sweetened beverages. | | | | | | | | |
| Minimize the frequency of food and | | | | | | x | x | x |
| meals away from home. | | | | | | | | |
| Feeding Related Behavior Core | | | | | | | | |
| Messages: | | | | | | | | |
| Feed your baby based on hunger | x | x | x | x | x | x | x | x |
| and satiety cues. | | | | | | | | |
| Include your baby at family meals. | | | | | | | | x |
| Limit television and screen viewing | | | | | | x | x | x |
| time. | | | | | | | | |
| Your baby should have adequate | | | | x | x | x | x | x |
| sleep. | | | | | | | | |
| Provide the opportunity for your | | | | | | x | x | x |
| baby to be physically active. | | | | | | | | |
| Study Outcomes: | | | | | | | | |
| Time Outcome Measure Obtained | 3rd | Birth | 1 mo. | 2 mos. | 3 mos. | 4 mos. | 5 mos. | 6 mos. |
| | Trimester | | | | | | | |
| Anthropometrics: weight, length | | via | Visit 1 | Visit 2 | | Visit 3 | | Visit 4 |
| | | record | | | | | | |
| 24-hour dietary recalls | | phone | Phone | Phone | | Phone | | Phone |
| Nutrition knowledge and feeding | | | Phone | Phone | | Phone | | Phone |
| related behavior proficiency | | | | | | | | |
| Biological markers of nutrition status | | | | | | | | Visit 4 |

| | Time Intervention Provided | | | | | |
|---|---|---|---|---|---|---|
| | 7 mos. | 8 mos. | 9 mos. | 10 mos. | 11 mos. | 12 mos. |
| Feeding and Nutrition Core | | | | | | |
| Messages: | | | | | | |
| Breastfeed your baby. | x | x | x | x | x | x |
| Introduce your baby to solid foods | x | x | x | x | x | x |
| and drinking from a cup at the | | | | | | |
| appropriate developmental stage. | | | | | | |
| Limit your baby's intake of juice and | x | x | x | x | x | x |
| sweetened beverages. | | | | | | |
| Minimize the frequency of food and | x | x | x | x | x | x |
| meals away from home. | | | | | | |
| Feeding Related Behavior Core | | | | | | |
| Messages: | | | | | | |
| Feed your baby based on hunger | x | x | x | x | x | x |
| and satiety cues. | | | | | | |
| Include your baby at family meals. | x | x | x | x | x | x |
| Limit television and screen viewing | x | x | x | x | x | x |
| time. | | | | | | |
| Your baby should have adequate | x | x | x | x | x | x |
| sleep. | | | | | | |
| Provide the opportunity for your | x | x | x | x | x | x |
| baby to be physically active. | | | | | | |
| Study Outcomes: | | | | | | |
| Time Outcome Measure Obtained | 7 mos. | 8 mos. | 9 mos. | 10 mos. | 11 mos. | 12 mos. |
| Anthropometrics: weight, length | | | Visit 5 | | | Visit 6 |
| 24-hour dietary recalls | | | Phone | | | Phone |
| Nutrition knowledge and feeding | | | Phone | | | Phone |
| related behavior proficiency | | | | | | |
| Biological markers of nutrition status | | | | | | Visit 6 |
| | Time Intervention Provided | | | | | |
| | 14 mos. | 16 mos. | 18 mos. | 20 mos. | 22 mos. | 24 mos. |
| Feeding and Nutrition Core | | | | | | |
| Messages: | | | | | | |
| Breastfeed your baby. | x | x | x | x | x | |
| Introduce your baby to solid foods | x | x | x | x | x | |
| and drinking from a cup at the | | | | | | |
| appropriate developmental stage. | | | | | | |
| Limit your baby's intake of juice and | x | x | x | x | x | |
| sweetened beverages. | | | | | | |
| Minimize the frequency of food and | x | x | x | x | x | |
| meals away from home. | | | | | | |
| Feeding Related Behavior Core | | | | | | |
| Messages: | | | | | | |
| Feed your baby based on hunger | x | x | x | x | x | |
| and satiety cues. | | | | | | |
| Include your baby at family meals. | x | x | x | x | x | |
| Limit television and screen viewing | x | x | x | x | x | |
| time. | | | | | | |
| Your baby should have adequate | x | x | x | x | x | |
| sleep. | | | | | | |
| Provide the opportunity for your | x | x | x | x | x | |
| baby to be physically active. | | | | | | |
| Study Outcomes: | | | | | | |
| Time Outcome Measure Obtained | 14 mos. | 16 mos. | 18 mos. | 20 mos. | 22 mos. | 24 mos. |
| Anthropometrics: weight, length | | | Visit 7 | | | Visit 8 |
| 24-hour dietary recalls | | | Phone | | | Phone |
| Nutrition knowledge and feeding | | | Phone | | | Phone |
| related behavior proficiency | | | | | | |
| Biological markers of nutrition status | | | | | | Visit 8 |

General Multi-Component Feeding Intervention Group:

The intervention comprises education and instructional modules, delivered to mothers beginning at 30-36 weeks gestation and followed by delivery of education modules at birth, and subsequently, not less than every two months, until the child is two years of age. The multi-component feeding education system may include education modules that deliver specific, core messages, and media tools to support the education module content. All dyads will receive the same messaging.

The education modules may be simple, practical, and specifically focused on addressing factors significantly associated to childhood obesity, based on published observational research. The core messages will also be focused only on actionable, potentially modifiable, parent related feeding behaviors.

The media tools that help to support educational module content may include, for example, videos of hunger and satiety cues appropriate to each developmental stage, a menu planner, visuals of serving sizes, growth charts, breastfeeding trackers, and growth tracking tools, etc. The delivery of core messages and tools will be completed via a combination of vehicles: written (e.g., US mail delivered), web-based, video, and mobile phone applications.

The core messages and tools may be delivered at a time that is synchronized to each infant's developmental milestones. For example, the core messages and tools may be anticipatory such that the core messages and tools are delivered prior to the developmental stage that each infant will be approaching. The core messages and tools be may delivered sequentially, as the diet, feeding, and feeding behaviors of the child develop.

A summary of educational intervention time-frame and focus is provided on Table 4 above. A Registered Dietitian and/or certified lactation specialist will be available to provide reactive telephone support on a 24 hour basis.

Control Group:

The control group families will receive publicly available breastfeeding materials, and standard care feeding recommendations for infants and toddlers.

Outcome Measures:

Parent and infant data will be collected using web and/or phone based parent questionnaires, 24-hour dietary recall via telephone interview using a multiple pass through approach methodology (similar to the FITS surveys), anthropometric measurements, and blood sampling draws for assessment of biological markers associated with nutrient status. Table 3 above provides a schematic of the timing of outcome measures.

Inclusion/Exclusion Criteria:

Pregnant women, ages 18-45 years, with no previous children, in their 3rd trimester will be eligible for participation if they are able to freely give informed consent, have access to a telephone and access to the world wide web, able to communicate in English and willing to comply with the study protocol for a minimum of two years. Women with a self-reported pre-pregnancy BMI≧40 kg/m², with chronic medical conditions prior to pregnancy physician diagnosis including: Type 1,2 diabetes, PKU, severe mental and emotional disorders, celiac disease with gestational diabetes as diagnosed by a physician or health care provider will be excluded from the study. Infants born with severe congenital anomalies or born <37 weeks gestation, metabolic disease, or mental or physical disability that might interfere with growth, and/or the ability to feed orally, and/or physical activity will be excluded. Infants with chronic health problems that are known to adversely affect dietary intake, normal growth and development, or activity will be subsequently excluded from the analyses, but permitted to participate in the study.

Sample Size:

A sample of 1515 mother/infant dyads will be recruited for the study to detect a difference among groups in mean BMI z-score of 0.25 units at age two years of age. This sample assumes a 50% attrition rate, and provides 80% power to detect such a BMI change at the two-sided 5% significance level.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for reducing childhood obesity, the method comprising the computer implemented method of:
delivering a plurality of messages to a caregiver in an anticipatory and a sequential manner with respect to a child's developmental stage, the messages being related to modifiable factors associated with childhood obesity, and the delivering being performed using a non face-to-face method of communication; and,
the messages being personalized for the child based on the child's risk of becoming obese, as calculated using an obesity risk calculator,
wherein the obesity risk calculator comprises at least two sub-components, comprising a questionnaire and a science based algorithm for calculating obesity risk;
wherein the delivering starts in the mother's third trimester and lasts at least two years.

2. The method according to claim 1, wherein the child's risk of becoming obese is calculated using an obesity risk calculator based on information collected regarding the modifiable factors associated with childhood obesity, wherein one to all of the modifiable risk factors are assessed in the obesity risk calculator depending on the child's age.

3. The method according to claim 2, wherein the questionnaire includes questions about the caregiver's current level of performing the modifiable risk factors along with basic biographical or demographic information for the mother and the child.

4. The method according to claim 2, wherein at least one of the modifiable risk factors assessed in the obesity risk calculator is at least one of:
1) whether the caregiver feeds the child breast milk;
2) whether the caregiver feeds the child using responsive feeding practices;
3) whether the caregiver provides nutritious complementary foods and beverages at the appropriate developmental stage;
4) whether the caregiver ensures that the child has adequate sleep;
5) to what degree the caregiver excludes sugar sweetened beverages for infants and limits them for toddlers;
6) whether the caregiver fosters healthy eating behaviors through shared family meals and mealtime routines;
7) how much time the caregiver allows the child to spend watching TV or having other screen viewing time;
8) and to what degree the caregiver provides opportunities for physical activity for the child;
or combinations thereof.

5. The method according to claim 2, wherein responses from the questionnaire items are inputted into the algorithm, and the output is the child's percent chance of becoming overweight/obese within the first two years of age.

6. The method according to claim 2, wherein the obesity risk calculator calculates specific risk levels for each pertinent modifiable factor associated with childhood obesity.

7. The method according to claim 1, wherein the caregiver is pushed into the obesity risk calculator at regular intervals.

8. The method according to claim 1, wherein the information from the obesity risk calculator is used to make personalized modifications to the method of reducing childhood obesity.

9. The method according to claim 1 further comprising providing the caregiver with at least one education tool selected from the group consisting of a menu planner, visuals of serving sizes, breastfeeding tracker, growth tracking tools, and combinations thereof.

10. The method according to claim 9, wherein the at least one education tool is provided to the caregiver by a media source selected from the group consisting of mailers, email, video, telephone, printed sources, web-related applications, mobile phone applications, computer implemented programs, and combinations thereof.

11. The method according to claim 1, further comprising generating the specific risk for the child from each modifiable risk factor; and displaying the child's percent chance of becoming obese and the specific risks from each factor through a source selected from the group consisting of electronic message; printed report; printed graphic; text message; phone call; web related application; computer implemented program; mobile phone application; and combinations thereof.

12. The method according to claim 1 further including providing the caregiver with at least one support source selected from the group consisting of a registered dietitian, a certified lactation specialist, and combinations thereof.

13. The method according to claim 1, wherein the developmental stage is selected from the group consisting of birth+, supported sitter, sitter, crawler, toddler, preschooler, and combinations thereof.

14. The method according to claim 1 wherein the reducing childhood obesity is reducing a body mass index of a child.

15. The method according to claim 1, wherein at least one of the plurality of messages is: to the feeding and nutrition factors and is selected from the group consisting of “breastfeed your baby,” “introduce your baby to solids foods and drinking from a cup at the appropriate developmental stage,” “provide nutritious complementary foods and beverages at the appropriate developmental stage,” “exclude sugar sweetened beverages for infants and limit them for toddlers,” “limit your baby's intake of juice and sweetened beverages,” “minimize frequency of food and meals away from home,” and combinations thereof.

16. The method according to claim 1, wherein at least one of the plurality of messages is related to the feeding related behavior factors and is selected from the group consisting of “feed your baby based on hunger and satiety cues,” “include your baby at family meals,” “limit television and screen viewing time,” “your baby should have adequate sleep,” “provide the opportunity for your baby to be physically active,” “utilize responsive feeding practices,” “ensure that the child has adequate sleep,” “foster healthy eating behaviors through shared family meals and mealtime routines,” “limit TV and screen viewing time,” “provide opportunities for physical activity,” and combinations thereof; or combinations thereof.

17. The method according to claim 1, wherein the delivering to a caregiver a plurality of messages comprises instructing the caregiver to do at least one action related to feeding a child.

18. The method according to claim 1, further comprising distributing the report to the child's caregiver and health care providers involved in the care of the child.

19. The method according to claim 1, further comprising reducing the risk of developing type 2 diabetes, hypertension, heart disease, chronic diseases or Syndrome X.

20. (canceled)
